(19) United States
(12) Patent Application Publication
(10) Pub. No.: US 2026/0187240 A1
(43) Pub. Date: Jul. 2, 2026

(54) Cybersecurity Active Defense for Data Stored on Third Party Storage Systems

(71) Applicant: RackTop Systems, Inc., Fulton, MD (US)

(72) Inventors: Eric Bednash, Fulton, MD (US); Jonathan Halstuch, Fulton, MD (US); Paul Zuchowski, Westerly, RI (US)

(21) Appl. No.: 19/544,899

(22) Filed: Feb. 19, 2026

Related U.S. Application Data
(63) Continuation-in-part of application No. 18/489,778, filed on Oct. 18, 2023, now Pat. No. 12,561,437.
Application No. 18/489,778 is a continuation-in-part of application No. 17/521,676, filed on Nov. 8, 2021, now Pat. No. 11,868,495.
(60) Provisional application No. 63/113,697, filed on Nov. 13, 2020.

(51) Int. Cl. G06F 21/55; G06F 11/1446

(52) U.S. Cl. CPC G06F 21/554; G06F 11/1469; G06F 2221/034

(57) ABSTRACT

Cybersecurity active defense for data stored in third-party storage systems are disclosed herein. An example system includes an architecture coupled to a third-party storage system that provides file access to a plurality of users. The exemplary architecture is configured to protect the third-party storage system in a zero-trust manner from a malicious attack by a source system. The architecture includes a controller that is configured to preserve pre-change state for file-level operations of files in the file system in case they are indicative of a malicious event, prevent data exfiltration or data corruption of the files, provide an alert regarding the files, identify the files that were associated with the malicious event, preserve snapshots of artifacts associated with the files, present a graphical user interface that allows for restoration of the files, and restore the one or more of the files as requested.

### CROSS REFERENCE TO RELATED APPLICATIONS

This application is a continuation-in-part of U.S. application Ser. No. 18/489,778, filed on Oct. 18, 2023, entitled “Cybersecurity Active Defense and Rapid Bulk Recovery in a Data Storage System”, which is a continuation-in-part of U.S. application Ser. No. 17/521,676, filed on Nov. 8, 2021, entitled “Cybersecurity Active Defense in a Data Storage System,” now U.S. Pat. No. 11,868,495 issued on Jan. 9, 2024, which claims the benefit and priority of U.S. Provisional Application Ser. No. 63/113,697, filed on Nov. 13, 2020, entitled “Cybersecurity Active Defense in a Data Storage System,” all of which are hereby incorporated by reference herein in their entirety, including all appendices and references cited therein, for all purposes.

### TECHNICAL FIELD

This disclosure is related to the technical field of network and computer security. More specifically, systems and methods for providing cybersecurity active defense for unstructured files in a third-party storage system are described herein.

### SUMMARY

According to some embodiments, the present disclosure is directed to a system that comprises an architecture coupled to a third-party storage system that provides file access to a plurality of users, the architecture being configured to protect the third-party storage system in a zero-trust manner from a malicious attack by a source system, the architecture comprising a controller that is configured to: mount files of the third-party storage system; publish this mount point to the wider network; intercept, in real time, file-level operations of the files in the third-party storage system in case any operations are indicative of a malicious event; prevent data exfiltration or data corruption of the files; provide an alert to an administrator regarding the files; preserve a snapshot of an artifact associated with the files, so that one or more portions of the files that have been modified or deleted are recoverable to prior versions based on the snapshot, where the artifact comprises a journal of the malicious event; identify the files that were associated with the malicious event; present a graphical user interface that allows for restoration of the one or more portions of the files from the snapshot of the artifact associated with the files of the third-party storage system; and restore the one or more portions of the files as requested. After some configurable period has passed, the artifacts and snapshots are removed from the controller.

According to some embodiments, the present disclosure is directed to a method comprising enabling a microservices architecture on a controller coupled to a third-party storage system that provides file access to a plurality of users, the microservices architecture being configured to protect the third-party storage system in a zero-trust manner from a malicious attack by a source system; mounting files of the third-party storage system; intercepting, in real time, file-level operations of the files in the third-party storage system that are indicative of a malicious event; preventing data exfiltration or data corruption of the files; providing an alert to an administrator regarding the files; preserving a snapshot of an artifact associated with the files, so that one or more portions of the files that have been modified or deleted are recoverable to prior versions based on the snapshot, where the artifact comprises a journal of the malicious event; identifying the files that were associated with the malicious event; presenting a graphical user interface that allows for restoration of the one or more portions of the files from the snapshot of the artifact associated with the files of the third-party storage system; and restoring the one or more portions of the files as requested.

### BRIEF DESCRIPTION OF DRAWINGS

Exemplary embodiments are illustrated by way of example and not limitation in the figures of the accompanying drawings, in which like references indicate similar elements.

FIG. 1 is an example architecture where aspects of the present disclosure can be implemented for use.

FIG. 2 is an example screenshot of an example incident report that identifies Ryuk ransomware event.

FIG. 3 is a screenshot of an example user interface that can be used to recover files affected by the identified ransomware event.

FIG. 4 schematically illustrates an example data encryption architecture that can be used by the BrickStor Security Platform (BSP) system.

FIG. 5 is a screenshot of an example user interface that allows an admin to review permissions to the network file share and remove permissions or export the report for review by another stakeholder.

FIG. 6 is a screenshot of example indexing and file restore user interface that is available through the management interface or API call.

FIG. 7 schematically illustrates an example hybrid storage system.

FIG. 8 schematically illustrates a copy on write file system that enables the instantaneous creation of snapshots and clones.

FIG. 9 schematically illustrates the replication of snapshots with encryption between BSP systems.

FIG. 10 is a flow chart of an example method of providing cybersecurity active defense.

FIG. 11 is a flow chart of another example method of providing cybersecurity active defense.

FIG. 12 is a simplified block diagram of a computing system, in accordance with some embodiments.

FIG. 13 is a flow chart of an example method of providing cybersecurity active defense and rapid bulk recovery.

FIGS. 14-20 are exemplary screenshots of an example graphical user interfaces (GUIs) utilized for rapid bulk recovery, in accordance with some embodiments.

FIG. 21 illustrates an example architecture of an exemplary security platform, in accordance with some embodiments.

FIGS. 22A and 22B provide a flow diagram of an example method of the present disclosure.

FIG. 23 is an example architecture for file activity journaling to intercept changes and create artifacts.

FIG. 24 is an example architecture for file activity journaling of read operations.

FIG. 25 is an example architecture for file activity journaling for creating files or directories.

FIG. 26 is an example architecture for file activity journaling for a write new operation.

FIG. 27 is an example architecture for file activity journaling for write existing (overwrite) operation.

FIG. 28 is an example architecture for file activity journaling for a delete operation from the perspective of a rtfs overlay filesystem.

FIG. 29 is an example architecture for file activity journaling for a delete operation from the perspective of a rtfsd service of a security

FIG. 30 is an example architecture for file activity journaling for ACL (access control list) changes, or permissions/owner/group changes.

### DETAILED DESCRIPTION OF EXAMPLE EMBODIMENTS

### Overview

Unstructured file systems (also referred to herein as Network Attached Storage (NAS) systems) use privileged user access controls, but they are vulnerable when user accounts are hijacked through a ransomware attack or a malware attack and increase the damage that such an attack can do to a business, company or organization. Unfortunately, using traditional methods, it may take weeks or months to detect, determine and access the extent of the damage that was caused by a ransomware or a malware attack, as one of the initial steps towards data recovery.

Specifically, there is a need to monitor, detect and stop malicious activity from occurring in real-time in a NAS system, to address the security issues that arise in the context of ransomware and malware attacks. If the malicious activity is stopped early enough, then the ransomware attack may be successfully defeated since potentially no data may be exfiltrated or encrypted.

Unstructured data accounts for approximately 80-90% of the data in most organizations today. By 2023, it is estimated that unstructured data will account for 93% of all data worldwide. And in 2020 damage from ransomware exceeded $20 billion. This explosion of unstructured data and evolving cyber threats has introduced new challenges for infrastructure teams and the C-suite beyond storage density and performance. With information technology decisions being more influenced by security and compliance, the requirement to protect data from natural disasters, breaches, insider threats, and cyberattacks has become critical. To effectively protect data, an organization needs a way to understand where the data resides, the sensitivity of the data, and who has access to each file. Data critical to business operations should be available to enable and accelerate positive business outcomes, but this need creates significant demands on data agility, mobility, and privacy—just to name a few.

The present disclosure pertains to a data security platform that fuses advanced cyber and metadata intelligence capabilities with a high-performance, unstructured file platform to solve the most difficult and pressing problems of ransomware, data theft, insider threats, and regulatory compliance. This fusion of technology is defined as CyberConvergence, which is rooted in the principles of zero trust.

Some embodiments include storage systems that remove the burden of typical multivendor solutions with a single, easy-to-use convergence of storage and cybersecurity on one platform that is far easier and faster to implement and manage. Having a single integrated solution results in a significantly lower total cost of ownership.

An example data storage system of the present disclosure can be embedded with military-grade security, using multiple levels of encryption, built-in key management, and data protection with immutable snapshots. These features in combination with user behavior analysis and proactive remediation result in a solution that is actively protecting data stored on the data storage system.

The systems and methods herein provide a Zero Trust and a data centric model. To be sure, Zero Trust is a model for implementing security and explicit trust at every level of an IT architecture. While traditional Zero Trust focused predominantly on network security, these systems and methods have evolved the concept to include data security so that the most critical assets are protected not just when they are in-flight on the network, but also when they are at rest within the data system.

To successfully employ this concept, a change in perspective switches the context of enterprise architectures and security from the “network” to the “data”. Once data becomes the focal point of security, the insufficiencies, gaps, and vulnerabilities of existing data storage technologies become very apparent. One example system is referred to as the BrickStor Security Platform (hereinafter “BSP system”).

The BSP system can implement policy-based data management. That is, the BSP system can use policies to ensure data storage is properly provisioned and maintained in accordance with best practices and organizational governance. This approach enables user self-service and workflow automation with centralized governance. The BSP system uses workload-based storage profiles that reduce or eliminate the need for admins or users to determine the best storage and security settings. This approach allows the storage system to automatically optimize itself for the workload. Each storage profile has an associated data protection profile that automatically starts when new storage is provisioned, thus ensuring data is protected against natural disaster, human error, or cyber-attack.

Many regulations and standards (e.g. NIST standards) that are relevant in commercial and government sectors focus on the same controls relative to data. These controls mainly focus on data security, access control, and data retention. The BSP system simplifies compliance by enabling users to set policies and controls on the data to maintain continuous compliance. Audits and compliance require an organization to explain how they deploy the controls and demonstrate control compliance through a body of evidence. BSP system is designed to meet these controls and provide exportable and immutable evidence, such as logs or daily reports. Three primary examples of these standards include data encryption for data security, privileged access management, and data protection policies for data retention.

Traditional storage solutions require external, network-based, third party compliance software to scan network shares, review permissions, and detect sensitive content in data. There are two significant security and performance pitfalls with this approach. First, these external tools require a privileged user account to scan all data, which creates an undefendable attack vector for cyber attackers to exploit. Privileged service account attacks are nearly impossible to detect because their normal activity is similar to data exfiltration. Second, external tools place a significant load on the system by stealing bandwidth and IOPS from the operational use of the storage and polluting the cache with unnecessary data. With a CyberConverged approach, data is analyzed internally, negating the need for a privileged account. That attack vector is eliminated entirely, allowing faster response when under attack. Since data is being analyzed as it is written to the BSP system, there is no need for extra expensive I/O or adjusting cache policies.

In some embodiments, systems and methods disclosed herein describe an active defense capability that is embedded within a storage system to detect and stop a malicious activity, such as a ransomware attack, from occurring in real time or near real-time within the storage system.

In certain embodiments, the systems and methods described herein enable data stored within the protected data storage system to detect and stop the spread of malicious activity, including but not limited to, ransomware attacks, data exfiltration attacks, insider threats, and data destruction attacks. Specifically, embodiments described herein provide for a real-time or near real-time analysis of data as it is being operated on, including all data and metadata operations (read/write/modify/metadata operations), for detecting attack patterns.

Furthermore, in exemplary embodiments, the system detects, in real time or near real time, a wide range of attacks, including but not limited to, attacks by a malicious insider, unusual amounts of data being transferred, data access from an unusual or unknown IP address, any type of intrusion or breach, malicious activity or any other activity that is unusual for a user's account that may potentially rise to the level of a security breach or a malicious attack on the NAS system.

Furthermore, the system can not only detect a malicious intruder or unauthorized user, but it can also stop the malicious activity that is taking place in real time or near time. In some embodiments, the system will cut off the intruder's access to the storage system altogether, thereby stopping the attack from occurring. Also, the system will alert the system administrator that an attack is occurring, so that the system administrator can immediately investigate, conduct forensic investigation, and take any further corrective actions as needed.

The data that is typically protected by the system as described herein is the corporate data or the important central business data of the organization, as opposed to other types of data. In exemplary embodiments, the system can perform real time data collection, real time data analysis, and post-analysis on the whole body of data for any given period of time.

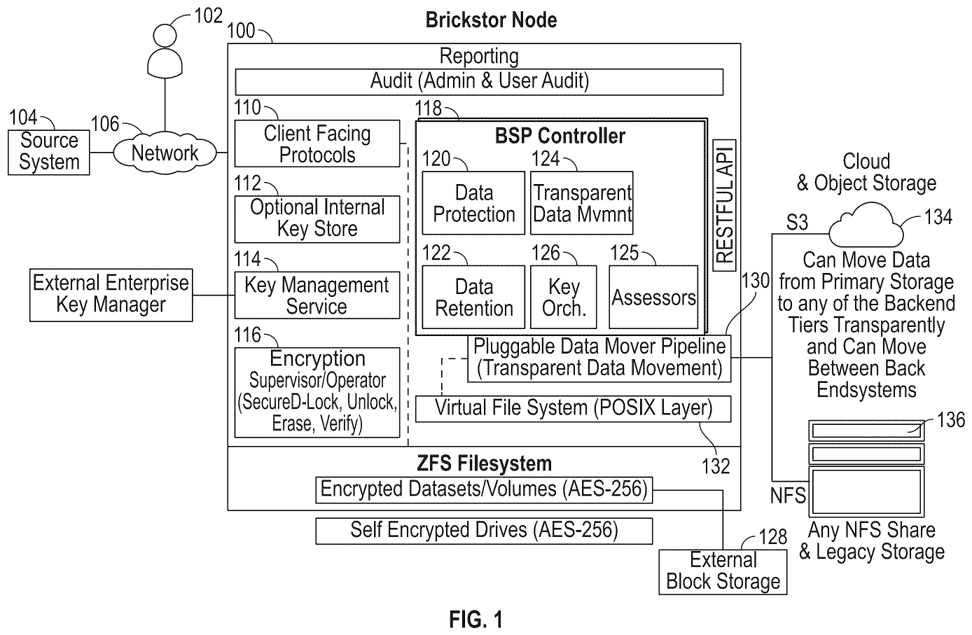

Referring now to FIG. 1, which illustrates an example architecture of a BSP system 100, which is a protected storage system, a client 102, source system 104, and a network 106. The network 106 can include combinations of networks. For example, the network 106 may include any one or a combination of multiple different types of networks, such as cellular, cable, the Internet, wireless networks, and other private and/or public networks. The network can include both short and long-range wireless networks.

Prior to describing the BSP system 100, various definitions that may be used herein will be provided for purposes of clarity of description. The client 102 or user will be understood to refer to a system that is used to access data from a file storage system 108 of the BSP system 100 over the network 106. The source system 104 is a computer or device where the malicious behavior is originating from. Some embodiments and use cases may refer to the use of S3 (Simple Storage Service protocol), SMB (server message block file sharing protocol) and/or NFS (network file system file sharing protocol). For example, the client 102 can use SMB, NFS, and/or S3 (or other equivalent protocol) to access the BSP system 100.

As noted above, the BSP system 100 can implement a CyberConverged data security approach that leverages a high-performance, RAM (random access memory) centric architecture to deliver integrated security and compliance features in the ideal location of the data pipeline, without sacrificing IOPS (input/output operations per second) or exposing data through unnecessary privileged account.

The BSP system 100 employs a portable microservices architecture that works cooperatively with common interfaces to provide extensible data management capabilities. The BSP system 100 can comprise a secure read-only operating system that leverages the power of ZFS, a 128-bit file system, to provide advanced high-performance storage capabilities. The architecture is flexible and allows the BSP system 100 to front other storage solutions (both block and file), thereby enabling data security and compliance capabilities into an environment without completely having to replace legacy equipment. This same approach provides a secure and compliant mechanism to leverage cloud technologies such as an S3 compatible object store.

The BSP system 100 can include client facing interface 110, an optional internal key store 112, a key management service 114, and an encryption service 116. In some embodiments, a BSP controller 118 can include logic that comprises data protection 120, data retention 122, transparent data movement 124, and key orchestration 126. As noted above, the file storage system 108 includes a ZFS Filesystem that includes encrypted datasets and volumes. Encryption protocols can include AES-256 or another equivalent protocol. In some instances, self-encrypting drives can be used. An external block storage system 128 can be included in some embodiments.

In general, the BSP system 100 can be configured to detect and stop insider threats and ransomware attacks. The BSP system 100 automatically maintains immutable copies of individual files or the entire file system for rapid file level recovery. The BSP system 100 instantly reports on what files were accessed, as well as alerts security and infrastructure teams via email and webhooks. The BSP system 100 also provides automatic incident reporting, customized responses, and integrates with SIEMs and SOARs.

A pluggable data move pipeline 130 can be coupled to a virtual file system (POSIX “Portable Operating System Interface”) layer 132, which in turn provides a virtual interface to the file storage system 108. The pluggable data move pipeline 130 allows for data transfer to cloud and object storage 134 and NFS share and legacy storage 136. In general, the pluggable data move pipeline 130 allows for transparent movement of data from primary storage to any backend tiers, as well as allowing for movement of data between backend systems, such as 134 and 136.

Broadly, the BSP system 100 provides a data-centric zero trust architecture with active defense and policy enforcement against unusual data access, ransomware, insider threats and excessive file access. The active defense features of the BSP system 100 can immediately alert security and infrastructure teams about suspicious behavior as well as block the suspicious user accounts and IP (Internet Protocol) addresses from accessing further data. As it pertains to ransomware, the BSP system 100 can be configured to create a cyber resilient architecture that stops and contains the ransomware attack, automatically generates an incident report and allows other non-offending users and applications to access data and continue to deliver critical services. The built-in incident management features make it easy to determine the source of the attack and immediately restore files that were affected from immutable snapshots and return the system to service quickly.

The BSP system 100 proactively protects unstructured data in the file storage system 108 using inline real time assessors that are looking for malicious and abnormal file activity conducted by a user or application. The BSP system 100 can implement active defense mechanisms that are extensible and can tie into an organization's security ecosystem through webhooks and email alerts. In addition to detecting abnormal access and employing a zero-trust evaluation model for file operations the BSP system 100 can enforce a cybersecurity data policy and stop an attack in real time before it is too late.

By default, the BSP system 100 has assessors 125 that detect, for example, excessive file access events such as reads, writes and deletes per data set. The assessors 125 can also detect unusual file access events, such as file access by a privileged account for example. For example, a privileged account, such as an administrator account, likely rarely performs file level actions. The BSP system 100 can also detect specific events, such as ransomware and/or another malicious event.

The following descriptions reference additional figures individually, however, references may be made to FIG. 1 throughout. In some instances, multiple figures may be referred to collectively.

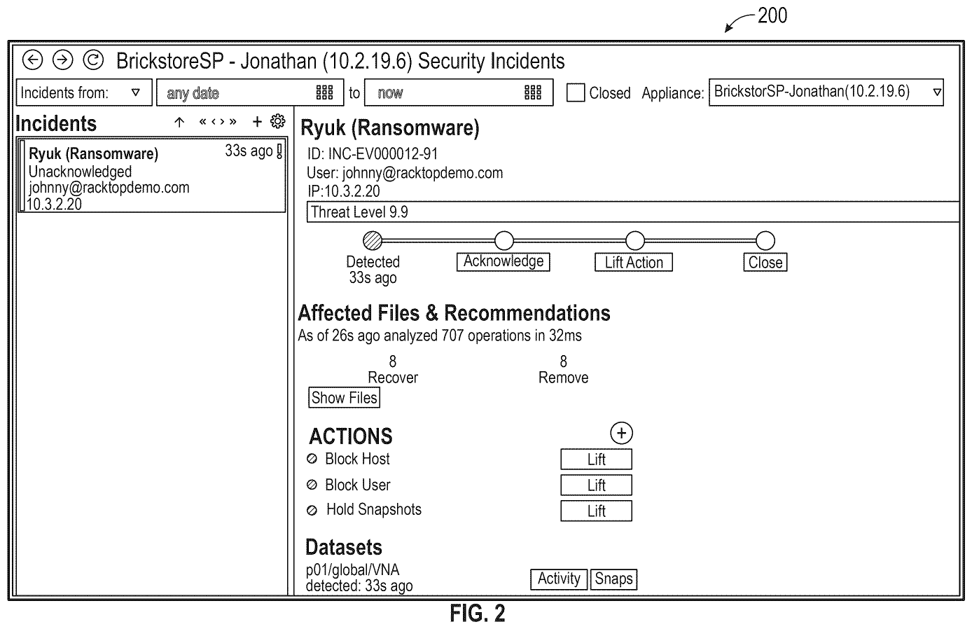

FIG. 2 is an example screenshot of an example incident report that identifies Ryuk ransomware event. The GUI 200 provides an event timeline that indicates when the malicious event was detected and acknowledged, as when certain actions “lift actions” were taken to remove blocks on certain IP addresses of users (such as source systems), as well as when the event was closed. The GUI 200 can identify how many files of the file storage system 108 were implicated in the attack. A user can select and see each of the files that were impacted, as well as remove the affected files. The GUI 200 also includes a listing of Actions. Actions that may be taken relate to specific accounts, source system identifiers, and other similar data related to the entity which were detected to be associated with the files that were the subject of the detected event. These accounts, addresses, users and so forth can be automatically blocked from accessing the file storage system 108. In addition to identifying users, machines, and/or networks implicated in the detected event, the admin can also choose to hold snapshots that were associated with the detected event. In instances where the admin determines that an account or machine was not involved in the detected event (or when the detected event was not actually malicious), the admin can remove a hold on the account or machine by selecting a “lift” button adjacent to the particular account or machine.

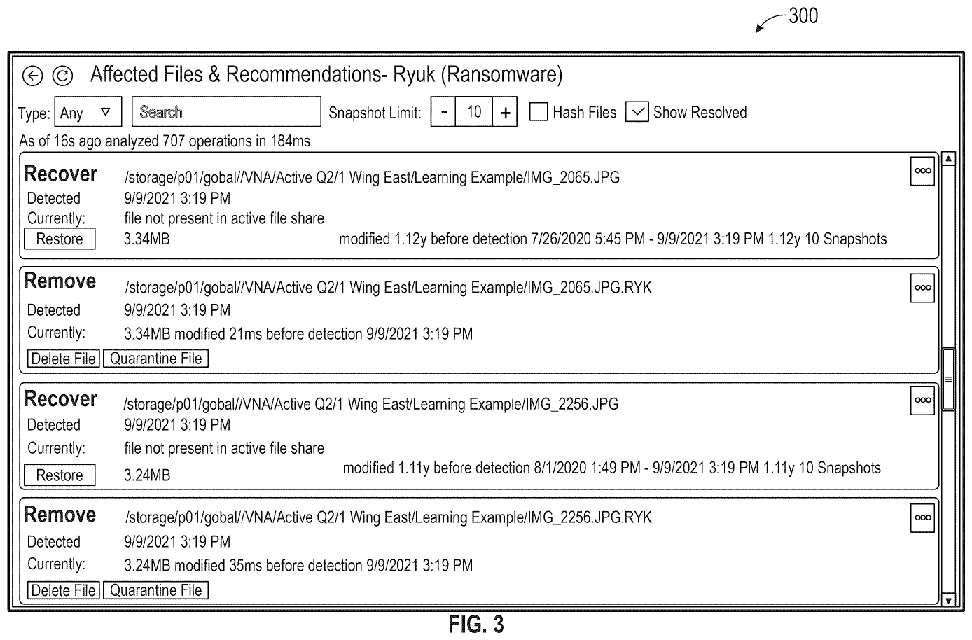

FIG. 3 is a screenshot of an example user interface 300 that can be used to recover files affected by the identified ransomware event. Each file is identified in terms of detection date and time, if the file has been removed from or sequestered in the file system, as well as if the file is available for deletion, quarantine, or restoration.

As noted above, the BSP system 100 can be configured to implement security policies. Organizations can add specific rules and incident responses based on their organizational needs. The BSP system 100 can function as another security sensor within a company's infrastructure to eliminate blind spots and detect attackers that may sidestep endpoints by going to devices that don't have endpoint monitoring. The BSP system 100 does not rely on agents but can audit all file access activity and inform a security team and other security applications for rapid response.

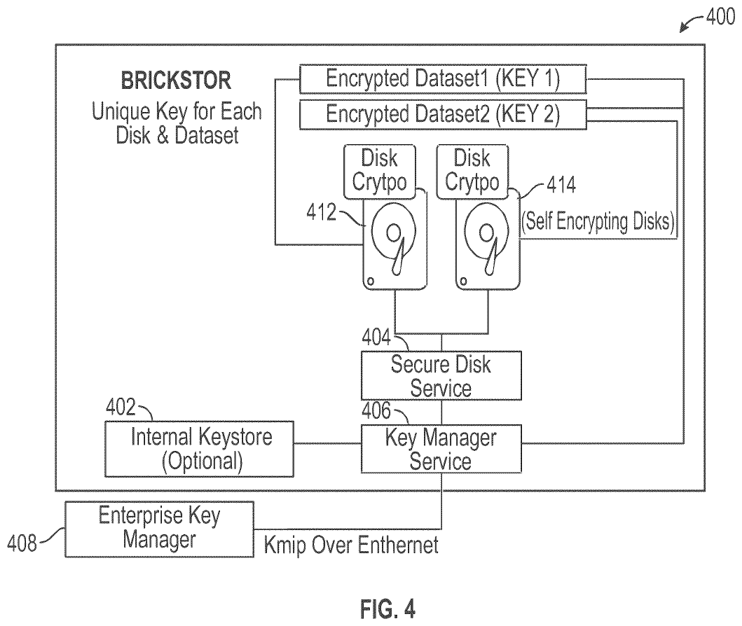

FIG. 4 schematically illustrates an example data encryption architecture 400 that can be used by the BSP system 100. The architecture 400 comprises an optional internal keystore 402, a secure disk service 404, a key manager service 406, and an enterprise key manager 408.

BSP system 100 provides two levels of encryption for data at rest and in flight. For data at rest, a first level of encryption uses FIPS (federal information processing) AES-256 level 2 validated drives, such as drives 412 and 414. The key manager service 406 in conjunction with the secure disk service 404 provisions and manages the encrypted bands on the disk.

Data is automatically encrypted and decrypted at line speed as it is written and read to the disk. This applies to both data and cache devices. The secure disk service 404 can crypto-erase drives as well to meet NIST media sanitization requirements. This is accomplished nearly instantaneously by resetting the data encryption key to a new random key. The second level of encryption for data at rest is accomplished by uniquely encrypting each dataset or volume in the pool with AES-256 encryption that leverages the Intel AES-NI instruction set to provide secure and performance efficient encryption. This can be leveraged in conjunction with compression and deduplication as it occurs after the inline and deduplication pipeline. Dataset encryption can be enabled during dataset creation, providing at rest protection for all user data (e.g., file contents, names, and attributes).

The default encryption algorithm is AES-256. Each user data block on the disk is encrypted via a per-dataset random 256-bit master key, which is generated during dataset creation and is inaccessible outside of the kernel. A master key may be encrypted via a user-provided wrapping key to allow periodic key rotation, which is controlled by a fully audited key management policy engine. Wrapping keys are random 256-bit keys that are generated by the key manager or user-provided.

When using dataset encryption, replication users also receive the benefit of replicating data to another location (i.e., remote datacenter or the cloud) at a block level without having to expose the key to the remote site. This encrypted data is replicated over an encrypted channel, meaning the data is encrypted twice in flight. For recovery purposes, data can just be recalled from the remote site back to the primary site or the key can be provided to the remote site to decrypt the data and reconstitute operations. Administrators can define a policy for how keys should be forwarded, based on organizational security requirements. Most external or third-party block level backup or replication tools require the re-encryption of data and suffer from data ballooning during the process. This encryption takes full advantage of the existing data protection service's differential data blocks and does not suffer from re-encryption, ballooning, or inflation.

A key manager service 406 manages encryption key material as well as maintenance functions, such as automatic key rotation, periodic key verification, key activity auditing, and reporting. The key management daemon of the key manager service 406 can store keys in a secure local database, on a removable disk, or connect to a KMIP (Key Management Interoperability Protocol) compliant enterprise key manager. The key orchestration architecture allows customers to use their own key material to provide the highest-level trust in key material as is often required by government agencies and financial institutions. These features provide complete transparency to the user about what is encrypted, key verification, key rotation dates, and more through built in reporting. The policy engine enables users to set a key rotation policy that will enable requests for new keys on a defined schedule for automatically rotating keys in accordance with organizational policy.

The BSP system 100 is configured to provide unique User Behavior Auditing (UBA) capability is the perfect defense against cyber-attacks and insider threats. UBA provides a real-time stream of user activity which captures extensive detail including the identity, source IP address, and protocol. User behavior activity can be analyzed within end-user facing user interfaces, through a data manager, or automatically forwarded to an RFC 5424 compliant SIEM (security information and event management) or anomaly detection engine. The manager can provide a feature rich data visualization interface which displays top users, hot files, and activity outside of normal business hours. It can also easily help determine who moved or deleted a file, a common problem for many IT organizations today. Future improvements to the UBA engine include automatically acting on data anomalies or known patterns to kick off system policy or user prescribed workflows.

The BSP system 100 supports full integration with active directory and LDAP (lightweight directory access protocol) to maintain consistent identity and access control. When properly configured, the BSP system 100 is capable of cross protocol access to files via both NFS and SMB.

The BSP system 100 can employ multiple methods to ensure system integrity and operating system integrity. Autonomous communication between enabled devices and the cloud support infrastructure leverages a combination of mutual TLS (transport layer security) and fingerprinting technologies to eliminate spoofing. All communications paths are SSL encrypted using SHA2 algorithms and management services support TLS inbound connections.

The BSP system 100 can expose an API (application programming interface) uses signed JWT (JASON web) tokens with RSA (Rivest-Shamir-Adleman) signature verification. Endpoints (e.g., clients and/or enabled data stores) are additionally secured with access control permissions tied to Active Directory™ user accounts. The operating system and upgrades are deployed as read-only images that are cryptographically signed and verified before installing. Operating systems are not installed like typical software. Instead, the BSP system 100 provides a secure RAP (resource allocation profile) format that enables images to be deployed in a similar manner to firmware on a hardware chip.

The BSP system 100 supports staging updates and rebooting during convenient hours. Multiple images can be loaded on the system at one time, which allows for booting into older images in the instance of an incompatibility. The BSP system 100 does not suffer from traditional complications, such as patch ordering issues and library variability because of the RAP deployment model. The entire OS can persist in a RAM disk, which means alterations to binaries will not persist. Configuration data can be saved between reboots. This “stateless” approach provides optimal security and ease of lifecycle management.

Administrators can run NIST compliant media sanitization operations in the BSP system 100 that may erase the data on the disk before re-purposing the system or destroying it. Metadata and access control settings are all stored with the data on the data pools. Thus, the controller may not require any reconfiguration or prior information about storage pools to import them, which guarantees 100% data portability even when some disks are missing. The controller can read all the necessary metadata from any member disk in the pool and self-configure and prepare shares from the data contained within the pool. For bulk data transfers, drives can be transported in an encrypted and locked state from one site to another. The keys can be separately transmitted electronically. When the disks arrive at the other site, the system will be able to unlock the drives and read all the data and access control settings from the pool, making them immediately available for use.

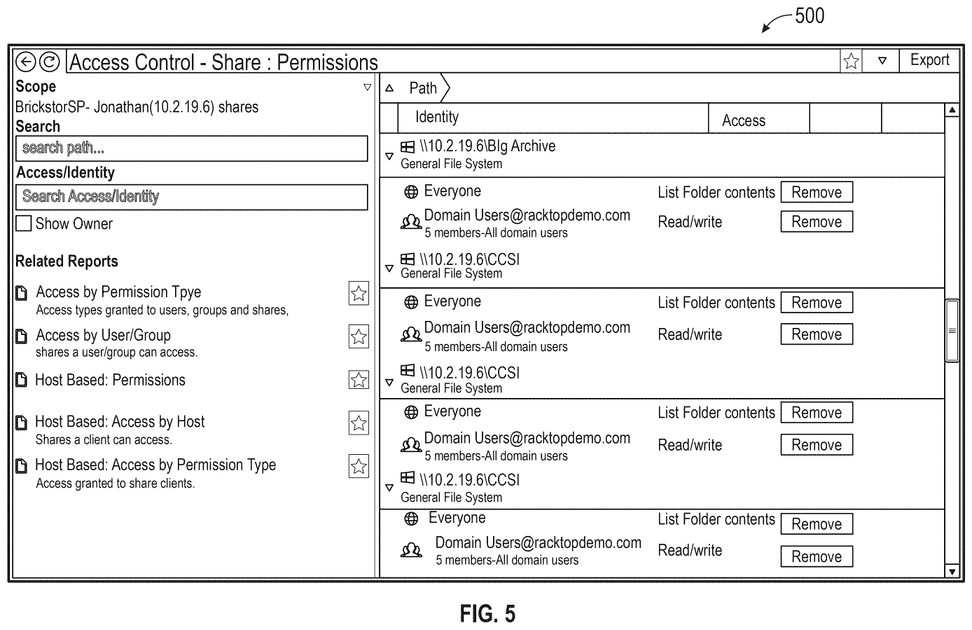

Referring now to FIG. 5, the BSP system 100 is configured to provide privileged access management. The BSP system 100 integrates with Active Directory/LDAP to enable data owners to review access control permissions. Data owners can see in real time what groups and users have access to a specified network share or review what network shares a user or group has access to on the BSP system 100. This built in capability can be extended into a workflow to provide data owners the ability to periodically review access management and acknowledge that access settings are still appropriate to meet the intent of the NIST standards. Furthermore, the system can create temporary access control permissions, so that users will have expiring access to a network share based on a temporary need or project task. This data owner centric approach puts the control with the people who have equities in the data and eliminates the storage admin as a middleman or obstacle to accurate and effective access management. Changes to access control settings can be logged for review and compliance purposes. In the event of a ransomware attack, explicit deny controls are placed at the top of the access control tree to prevent data exfiltration or continued corruption as illustrated in the GUI 500 of FIG. 5.

With respect to data retention, the BSP system 100 can implement a data protection engine that includes a collection of services which manage automatic snapshot creation, expiration, and retention based on pre-defined policies. Data protection is always on, and inherent, which means that as new datasets are created, admins never have to remember to include that data. Custom retention holds can easily be added to override policy-based expirations. Users can also extend, reduce, or completely remove the original expiration period for the snapshot.

The BSP system 100 supports legal holds that can be assigned unique identifiers, such as project ID or investigation ID. This prevents data from expiring based on the normal expiration date to meet legal or special requirements.

Reports accessible through the BSP system 100 quickly display which datasets have current holds. Any data with a hold on it cannot be destroyed by any mechanism until all holds have been removed. Built-in retention reports allow users to review and monitor all data protection policies to ensure they are compliant with the organization's IT governance standard. Any deviations can be put back into compliance from within the interactive reporting screen. If retention standards change, admins can review current policies and adjust them to meet the new minimums or maximums. For example, if an organization's previous policy only required three years of data retention but a new policy requires seven years of data retention, an admin can change all appropriate policies system wide to increase retention from a single compliance screen in just a few clicks.

Administrative actions are audited and logged in a local database and can also be forwarded to an RFC 5242 compliant data store. This provides a complete accounting of all changes to the system that have been made, including changes in access control. This data can be reviewed within the BSP system 100 or with log forwarding on an external SIEM. The audit capability can also provide insightful information about who had access to data when performing forensic analysis or e-discovery. Providing a rapid understanding of what happened after an event, such as a cyber-attack, data loss, or malware incident can be invaluable in salvaging a reputation and providing accurate information to public relations and legal counsel.

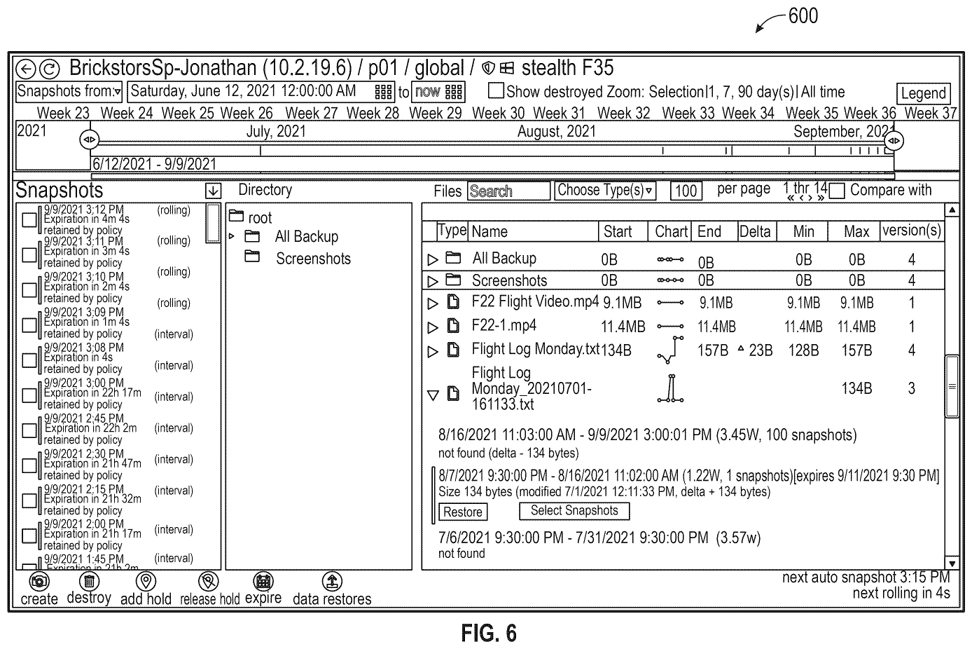

The BSP system 100 can also provide unique metadata intelligence services. For example, the BSP system 100 can provide indexing capabilities. The BSP system 100 comprises a metadata intelligence engine, which is comprised of multiple services that index and analyze file metadata. Each file's full metadata is indexed, including all versions in all snapshots, basic file information, magic numbers, access control settings, file type, and location to name a few. This is accomplished across hundreds of millions of files with limited system impact using a patent pending “fast indexing” approach which eliminates the need to re-index data as it is created or modified. Deleted files are also captured and stored to facilitate simple recovery. Indexes are available for all data, accessible via through a management interface or through API calls. An example indexing and file restore GUI 600 that is available through the management interface or API call is illustrated in FIG. 6.

The BSP system 100 enables unique data storage features. A unified global manager can be implemented that allows for global command and control of multiple deployments of the BSP system 100 through a single user interface. This unified management simplifies data management and enables rapid provisioning. Users can search for files and forecast data growth. The unified global manager provides admins with single click executable suggestions for resolving capacity contention or shortages. It is a powerful interface that simplifies storage administration and provides managers with a detailed understanding of return on investment and projected storage needs by department, application, or location.

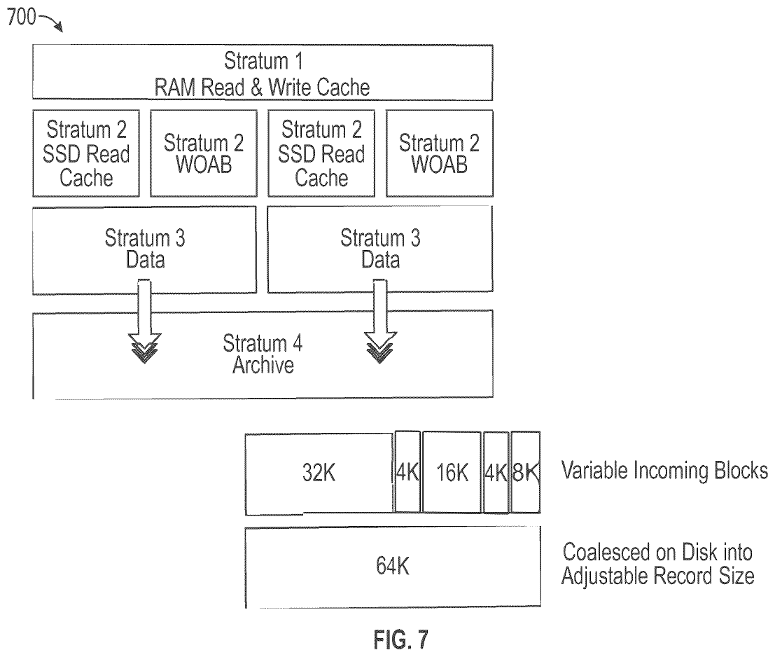

Referring now to FIG. 7, which schematically illustrates an example hybrid storage system 700. The architecture of the hybrid storage system 700 improves performance while reducing equipment costs. Hybrid storage combines spinning disks with other acceleration components like RAM and SSDs. The hybrid storage architecture leverages a stratified data placement model, providing revolutionary performance and cost benefits. A 4-Stratum architecture can be used to intelligently place data across DRAM, NAND Flash, and spinning disk with an architecture that is optimized for total performance. Typically, 70-80% of data IO requests are serviced by Stratum 1, comprising 100% DRAM at 300× lower latency than NAND flash in a Solid State Disk.

BrickStor SP minimally uses two strata—Stratum 1 for cache and Stratum 3 for data. Stratum 1 is 100% DRAM and is the layer 1 read and write cache. The data stratum can consist of SSDs or hard drives, depending on the use case. A single BrickStor SP appliance can concurrently have a variety of device types in the data stratum to support a variety of workloads and cost constraints. For example, within RackTop's customer base, SSD-only tiers support the most demanding random IO in support of specific relational databases or virtual desktops, while a set of 7200 RPM SAS drives in the data stratum support virtual machines, file shares, and less demanding databases.

Because Stratum 1 is 100% DRAM, it provides the lowest possible latency for shared storage. Stratum 1 cache is scalable to over 1.4 TBs of data per cluster with nanosecond latency. This proportion of Stratum 1 cache to Stratum 3 data capacity is a significant performance differentiator compared to other traditional and hybrid storage arrays, resulting in immediate and long-term cost savings. Write coalescing and transaction groups aggregate incoming blocks in RAM within Stratum 1, writing out to the data stratum in defined intervals to reduce disk thrashing due to intensive random IO. The system can leverage self-tuning algorithms to keep the most frequently and most recently used blocks of data in Stratum 1 to serve read requests with the lowest total latency.

Optional devices in the second stratum further improve read and write performance. The Write Optimization and Acceleration Buffer (WOAB) absorbs the impact of synchronous random I/O to the appliance and shields the data stratum even further from this performance burden. The WOAB offers DRAM latency without volatility, adding latency improvement benefit even to all SSD Stratum 3 configurations.

An optional read cache can be added to Stratum 2. The Stratum 2 read cache (S2RC) extends the capacity of the Stratum 1 DRAM cache acting as a level 2 buffer. The stratum 2 Read Cache will hold blocks of data when there is no longer enough space to hold them in Stratum 1, providing orders of magnitude better performance over a data stratum with SAS hard drives.

The fourth stratum is the archive stratum. Data can be replicated or tiered to this stratum. Transparent Data Movement (TDM) technology can tier data from Stratum 3 to Stratum 4 based on policy. Stratum 4 can take the shape of an archive data pool, another NFS capable storage array, or an object store. Any of these solutions can be located on premises or in the cloud.

Hybrid storage disclosed herein provides stratification model maximizes performance for data devices while allowing administrators to create different resource pools to meet a dynamic range of performance profiles. Pools can be optimized for large streaming data sets, small blocks with a lot of random IO, or archives where data is written and rarely read—ideal to meet mixed workloads in a cloud environment.

The BSP system 100 inherently supports CIFS/SMB, Apple File Protocol, NFS3/4.1/4.2, and iSCSI with no limit on the number of volumes or datasets presented. For security and compliance purposes, the platform focuses primarily on file protocols over client facing block protocols. With client facing block protocols, the data becomes opaque to the BSP system 100, meaning that the system cannot look introspectively into the data to report on items such as user behavior and access control or provide advanced data management features. An example, optimized BSP system deployment with block storage systems requires LUNs to be exposed over fibre-channel or iSCSI and system mounted, with data being shared and accessed through the file system and protocols implemented in the BSP system 100.

The BSP system 100 supports NFS 4.2 context security labels to provide support for mandatory access control as shared storage for SE Linux. With SE Linux and context security labels, the BSP system 100 is a high performance and scalable shared storage solution for multilevel security (MLS) implementations. MLS implementations allow a single storage solution to provide data across multiple domains at different classification levels. This is a critical capability in securing data while enabling cross-domain collaboration.

Getting to the lowest possible cost per gigabyte requires software features to optimize storage efficiency. Compression is a feature that has negligible impact on a system's performance but has an impact on capacity utilization. the BSP system 100 has compression algorithms available for use and leverages the appropriate algorithm for a particular workload. In some instances, a 2X+ capacity savings using the BSP system 100 implementation of LZ4. Each block is compressed independently and all-zero blocks are converted into file holes. To prevent “inflation” of already compressed or incompressible blocks, the BSP system 100 maintains a 12.5% compression ratio threshold below which blocks are written in uncompressed format. This early abort mechanism ensures that time is not wasted trying to compress data that is uncompressible. Not only does the BSP system 100 leverage compression for data on the disk in the data stratum but also in all of the caching stratums mentioned before, which translates into fitting more blocks into cache. Because all of the blocks are moving in a compressed format, the system requires less internal I/O bandwidth, thereby increasing system performance.

As a storage service provider to internal customers, it is often hard to predict or forecast the required storage amount for each customer. Thin provisioning by the BSP system 100 offers a method of oversubscription that allows for more flexible and cost-effective storage allocation analogous to how server virtualization has led to server consolidation. Thin provisioning provides efficient capacity management and space allocation that can result in another 50% savings in capital expenditures by eliminating reserved space. Traditionally provisioned storage systems leave admins with an average of 30% to 50% of their allocated space stranded and unused. Thin provisioning combined with capacity forecasting tools enable administrators to forecast when they will need to acquire new physical storage capacity or reallocate capacity. Reservations can be enabled on a per dataset basis to provide a guaranteed amount of capacity to organizations and network shares.

It is rarely the case where one size fits all. BSP system 100 dynamic block sizing capability ensures that the storage is optimized for the tenant's application workload on an application-by-application basis. With variable block size, space is efficiently utilized both in cache and on storage, having a positive impact to both capacity utilization and reduced I/O overhead. The BSP system 100 supports record sizes ranging from 4K to 1 MB.

Like compression, deduplication is performed inline and at the block level using a hash of the block. Deduplication is transparent to all other layers of the storage system. Unlike compression, there are some performance and resource tradeoffs to consider when leveraging deduplication on any storage array. The BSP system 100 leverages a deduplication table that is held in memory. Setting a smaller block size will increase the probability of deduplication but increase the size of the deduplication table. The BSP system 100 has onboard tools to analyze data on the system to estimate the benefit of enabling deduplication. For data protection reasons, the BSP system 100 keeps the first, second, and fourth copy of duplicative blocks. For highly duplicative environments with deduplication enabled, write performance can actually improve by saving the operation to disk. However, large deletes can take longer than normal because the system needs to check if it is the last block before each delete. Deduplication is always more effective and better performing at the application layer but there are times with very duplicative data that it makes sense to leverage deduplication at the storage layer. The BSP system 100 inline deduplication can be enabled on the fly per volume or dataset that has duplicative data and turned off for datasets that won't receive benefit.

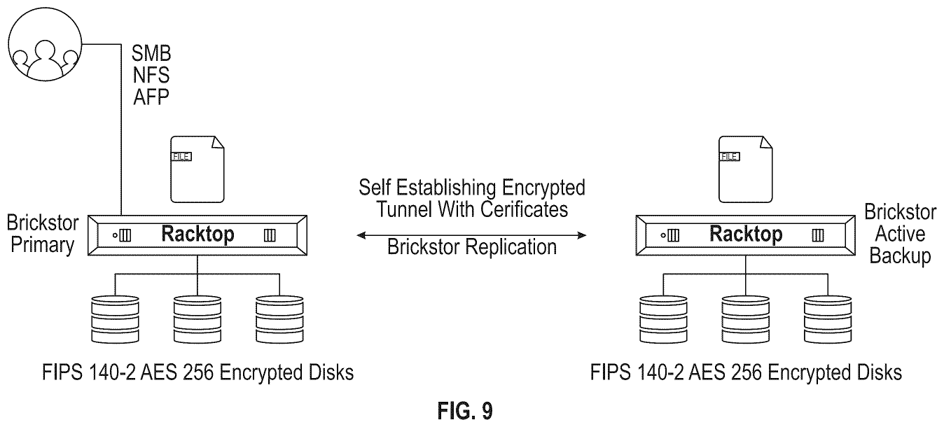

Data protection policies define how often data is snapshotted, retained, and replicated. Data is automatically snapped and retained, based on default data protection policies set by the type of storage profile or by user-defined custom data protection policies to meet specific business data protection priorities. FIG. 9, which illustrates an example GUI that identifies various data protection for a BSP system enabled on a datastore.

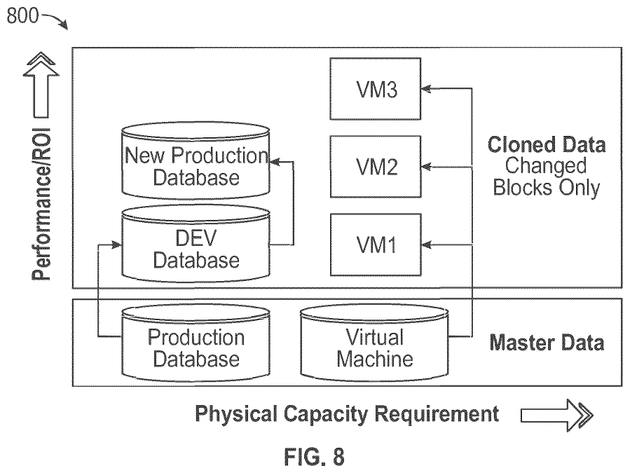

Referring now to FIG. 8, the BSP system 100 can implement a copy on write file system enables the instantaneous creation of snapshots and clones. At creation, there is no additional space required for snapshots. The BSP system 100 does not limit the number of snapshots you can create or retain per system and does not require pre-reserved capacity. This approach enables the rapid restoration of a version of an individual file or virtual machine from within the snapshot. Entire snapshots can be cloned to become operational for disaster recovery and backup purposes. Snapshots are a critical part of the BSP system 100 windowless backup and near zero recovery time objective, which enables true Enterprise disaster recovery and business continuity. Unlike competing file systems whose snapshot mechanisms are susceptible to auto-pruning attacks, the BSP system 100 snapshot mechanism is completely immutable, and policy driven, which eliminates ransomware attacks from destroying snapshotted data.

The BSP system 100 provides unlimited cloning capability that enables the instantaneous creation of zero footprint clones and acts as a pre-emptive, performance increasing, deduplication capability. Clones leverage the same core blocks of data as their parent snapshot, which improves performance and caching, since the BSP system 100 caches the most frequently and most recently used blocks of data in DRAM within Stratum 1.

Clones are a great way to run tests or upgrades against a point in time instance of a database or virtual machine to validate patches and upgrades. In large environments with many tenants, offering a cloning capability allows tenants to create hundreds or thousands of clones of the same baseline image while utilizing nominal additional physical capacity. An example clone management architecture 800 is illustrated in FIG. 8.

An example architecture for replicating data is illustrated in FIG. 9. The BSP system 100 enables Smart Folders, which in real-time converts common directories into unique independent file systems. With Smart Folders enabled, the BSP system 100 automatically creates a unique file system on the fly when the client creates a folder over SMB or NFS. This enables traditional POSIX folders in smart folder datasets to have their own storage profiles, encryption keys, and data protection policies. This is ideal for home directories as an isolated dataset that can be automatically created when a new user account is created. It can also be used with virtualization to create clones of VMs, providing space and performance benefits above and beyond deduplication.

The BSP system 100 provides block and file replication technologies that are WAN-optimized and can securely transmit snapshots between systems. The BSP system 100 block level replication only transmits the changed blocks between snapshots to expedite transmission and reduce bandwidth usage. The BSP system 100 block level replication has dynamic WAN bandwidth throttling, multi-stream transfer for high-latency, high-bandwidth networks, a lottery-based prioritization engine based on the size, importance, and age of data, and the ability to pause and resume replication without starting over. Replication will auto-recover and restart at a checkpoint if interrupted before completing the replication of an entire snapshot. Replication can occur within the same system, or between multiple storage appliances either over a LAN, WAN, or public network in the cloud. Administrators can choose whether they wish to forward and replicate dataset and drive encryption keys to the remote system. The BSP system 100 also supports file level replication to other NAS platforms as well as S3 compliant object storage.

All of the features for tractable disaster recovery are built into the BSP system 100, from data protection policies to replication and file recovery. Integrated disaster recovery features ensure data is always protected and that recovery is faster to achieve (lower RTO) and probability of success is near 100%. The architecture enables users to recover using a second physical BSP system 100 appliance or recover in the cloud.

The BSP system 100 supports a dynamic lottery and priority scheme to ensure the most important data is replicated first, driven from the context of the data, operational factors, backlog, preset priority label, and age. The BSP system 100 has five preset levels of priority. The highest level “Critical” will block other data waiting to be replicated until it has completed. The “High”, “Medium”, and “Low” binned datasets use a scheme to ensure they are replicated in a fair share manner based on the amount of data to replicate, how long they have been waiting in queue and their relative priority. The lowest priority bin, “Background”, will only replicate when nothing else needs to replicate and will be pre-empted by any snapshot with a higher priority level. Snapshots with a “Background” priority are never guaranteed to complete. Admins can temporarily change the priority of a dataset to handle special situations or ensure a specific snapshot is replicated immediately.

The BSP system 100 supports one-to-many global file level replication to enable the movement of files to fit a dynamic number of operational workflows. With the File Reflection service in the BSP system 100, files can be multi-way replicated to another SMB or NFS share, as well as an S3 object store. Data can be replicated and synced between multiple geographies, simultaneously preserving last writer changes.

The BSP system 100 provides high availability using dual controllers connected to shared disks over SAS, or when fronting block storage arrays via a shared LUN over fibre-channel or iSCSI. During normal operations, the controllers participate in an Active/Active cluster mode where each controller is managing IO to one or more pools. Pools are members of a resource group, which consists of an IP and one or more pools. During a failover process, the system moves the resource group from one controller to the other. During a resource group failover, the system removes the IP from the original controller and then advertises on the new controller after the pool(s) are successfully imported and datasets are mounted and shared via the appropriate protocol. This operation can be completed in a rapid manner so that clients do not experience a loss in connectivity to the data store. For example, virtual machines running on the data store can continue to run during a failover operation.

The high availability architecture leverages SSDs for write buffers and read cache. These devices are viewable by both controllers so that there is no data loss in the event of a controller failure or power loss. The BSP system 100 uses RAM as the primary read and write cache, but does not acknowledge that data has been committed to stable storage for a synchronous write until it has been written to the write buffer or the data disk. After data is written to the write buffer, the transaction can be replayed by any controller to write the data correctly to the data disks. The BSP system 100 supports 2-node clusters for high availability, but n-way clustering is also contemplated.

The BSP system 100 supports several RAID schemes. Each pool has an associated RAID scheme, but a system can have multiple pools, each with a different RAID scheme, managed by the same controller or in a cluster.

The BSP system 100 supports mirrored, triple mirrored, single parity RAID, double parity RAID, triple parity RAID and striped (no RAID) RAID schemes. In some embodiments, disks are put into RAID groups called vDevs and then data is striped across one or more vDevs to create a storage pool. When multiple vDevs are striped, it creates a RAID-10, RAID-50, RAID-60 or RAID-70 (triple parity) scheme for the data drives based on the parity level of the vDevs.

The write buffer can be mirrored for protection. Read cache is typically not protected with a RAID scheme because the loss of Read cache will not result in data loss. The BSP system 100 supports hot spares that will automatically be added into a vDev to replace a failed device and begin to rebuild based upon the RAID scheme.

When considering a RAID scheme, it is important to understand the intended workload for the pool. The RAID scheme and the number of drives in the system will affect performance and the usable percentage of raw capacity. For this description, raw IOPS are the IOPS provided by the storage pool without the benefit of caching. In a mirror configuration, each vDev delivers the raw write IOPS of a single device/disk and the read IOPS of both devices/disks since the system needs to write to both disks and read data from only one disk. For single, dual, or triple parity schemes, the vDev only delivers the IOPS of one device/disk because it must write data and read data to all devices in the vDev for a successful read or write operation. To add additional raw IOPS to the pool, the admin must add more vDevs to the Pool. When configuring a pool with a specific number of disks, there is a trade off on usable capacity versus IOPS and latency performance. If an admin were to create a pool out of 24 disks, they have several ways to create pools and leverage all available drives.

When cache is considered, the IOPS of the solution improve drastically even with 7200 RPM SAS Drives. For an HA cluster with two pools and dual 10 Gb Ethernet to each node, the system can deliver 140,000 IOPS for a 32K 50/50 Read/Write Workload. For workloads that require high IOPS with consistently low latency, an all flash pool is an ideal choice. Below are performance metrics that can be demonstrated on pools with mirrored vDevs with current generation SAS flash drives.

For throughput sensitive workloads, the single, dual, and triple parity schemes are effective and economical. In some embodiments, data is written to and read from all disks in the pool to create aggregate bandwidth. The system is intelligent and will automatically bypass the write buffer and write directly to disk for throughput biased workloads. As an additional performance accelerator, the system will intelligently prefetch data for multiple client streams and move the data from disk to cache. The example below shows the example performance of a lidar image modeling workload over SMB using 10 Gb Ethernet. The system is a single host with Dual e5-2620v4 CPUs, 256 GB of RAM. The pool consists of five dual parity 6-disk vDevs. This workload uses 32 client threads to initially load the data and then reads the data to process and model the data.

In day-to-day use, when a damaged block is read and detected, the file system of the BSP system 100 automatically repairs itself by copying data from a known good copy or recreating it from parity blocks. Self-repair occurs on the fly as blocks are read. The BSP system 100 can be scheduled to run a preemptive “scrubbing” process, like ECC memory scrubbing, that operates on live and in-use file systems at low IO priority with minimal performance impact. This is valuable for data that is rarely read and may be susceptible to bit rot on disk. Self-healing eliminates silent data corruption and ensures that blocks of data delivered are 100% intact.

The BSP system 100 can expand and resize pools can be dynamically (up or down) by adding, removing, or growing vDevs to the pool. This means capacity can be expanded at any time without interruption or downtime, and disks can be upgraded in place without any data migration. Write buffers and read cache can also be added or removed from a pool at any time without interruption. Best practices dictate that pools are expanded before they become 70% full. This avoids a large imbalance within a pool where read operations are coming from a subset of the pool vDevs, causing an impact to performance. As new data is written to the pool, it will be written to all disks and vDevs within the pool so that it will automatically begin to rebalance.

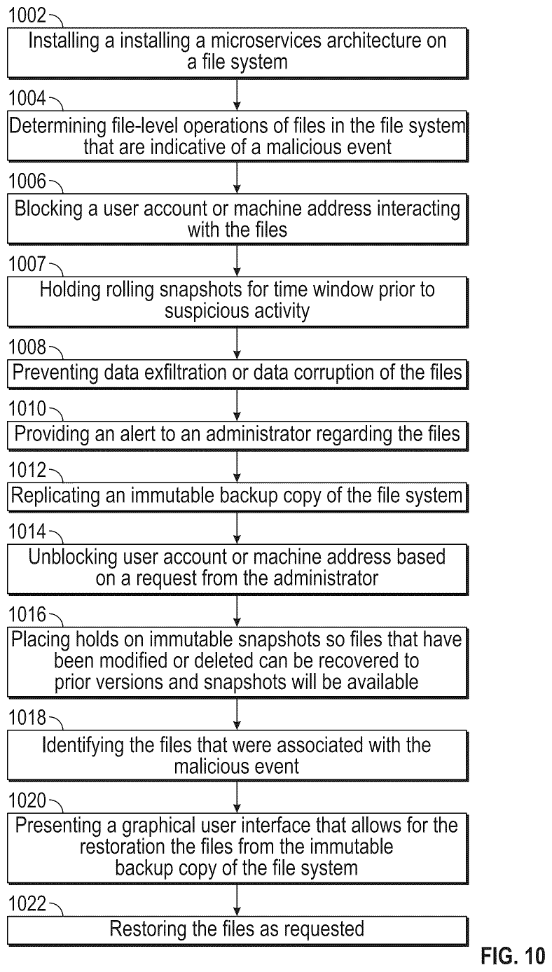

FIG. 10 is a flowchart of an example method of the present disclosure. The method can include a step 1002 of enabling a microservices architecture on a file system. As noted above, the microservices architecture is configured to protect the file system in a zero trust manner from a malicious attack by a source system. The method can also include a step 1004 of determining file-level operations of files in the file system that are indicative of a malicious event.

The method can include a step 1006 of blocking a user account or machine address interacting with the files, as well as a step 1008 of preventing data exfiltration or data corruption of the files. According to some embodiments, the method can include as step 1010 of providing an alert to an administrator regarding the files. The method can include a step 1012 of replicating an immutable backup copy of the file system.

The method can include a step 1014 of unblocking user account or machine address based on a request from the administrator. This can be based on an admin using a GUI provided by the microservices file system protection service.

The method can include a step 1016 of placing holds on immutable snapshots so files that have been modified or deleted can be recovered to prior versions and snapshots will be available, as well as a step 1018 of identifying the files that were associated with the malicious event. In some embodiments, the method includes a step 1020 of presenting a graphical user interface that allows for the restoration the files from the immutable backup copy of the file system, and a step 1022 of restoring the files as requested.

It will be understood that the order of the steps disclosed in the various methods herein are not intended to be limiting, unless specifically claimed as such. Thus, various steps can be omitted or their order of operations rearranged as would be apparent to one of ordinary skill in the art.

In some instances, the method may include a step of identifying excessive file access events comprising reads, writes and deletes per data set, as well as identifying unusual file access events by a privileged account. One embodiment includes a step of identifying a ransomware event.

According to some embodiments, the method may include establishing a virtual file system and pluggable data mover pipeline, and transmitting files on the pluggable data mover pipeline for external storage in a cloud or other network file system.

In some instances, the method includes establishing an encryption manager that provides a first level of encryption for the files when at rest and a second level of encryption for the files when transmitted, as well as determining a real-time stream of user activity related to the file system, which captures details including an identity, a source IP address, and a protocol.

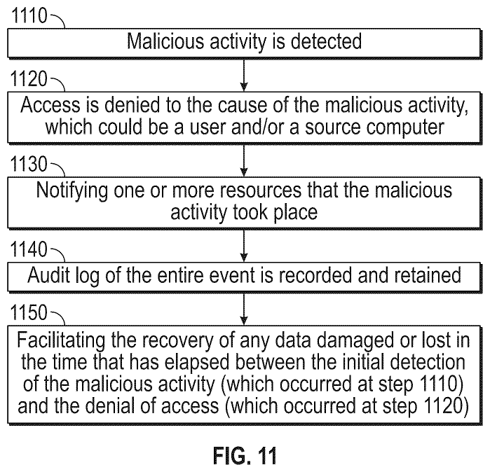

FIG. 11 is a flowchart of an example method for providing cybersecurity active defense in a data storage system. The method begins with step 1110, where a malicious activity is detected. The malicious activity may be detected utilizing any number of ways and methods, including but not limited to, using attack pattern detection technique, detecting specific ransomware signatures, detecting data exfiltration, detecting that an unusually high volume of data is being accessed or deleted, detecting that an account is being accessed by an unknown system or IP address, detecting that the user's computer has been infected or compromised, and the like.

Then, at step 1120, access is denied to the cause of the malicious activity, which could be a user and/or a source computer. At step 1130, the method continues by notifying one or more resources that the malicious activity took place. At step 1140, an audit log of the entire event is recorded and retained. Finally, at step 1150, the method facilitates the recovery of any data damaged or lost in the time that has elapsed between the initial detection of the malicious activity (which occurred at step 1110) and the denial of access (which occurred at step 1120). Alternatively, in other embodiments, at step 1150, the method facilitates the recovery of any data damaged or lost in the time that has elapsed prior to initial detection of the malicious activity (which occurred at step 1110) and the denial of access (which occurred at step 1120). For attack types and incidents where the rule is set to only alert and not block the user from accessing further data the method facilitates the recovery of any data damaged or lost both before and after incident detection. If the incident rule was not set to block the user and instead the incident rule was just to notify the user, then the system will allow the user to restore files after the incident was detected. As mentioned before, in certain embodiments, the method for providing cybersecurity active defense occurs in real time or in near real time, so the system administrator can be alerted of malicious activities in a timely manner. The system administrator can view what files were accessed by the malicious activity. As one step towards data recovery, the system administrator can revert the data back to the last version saved (via a data snapshot) taken prior to the occurrence of the malicious activity.

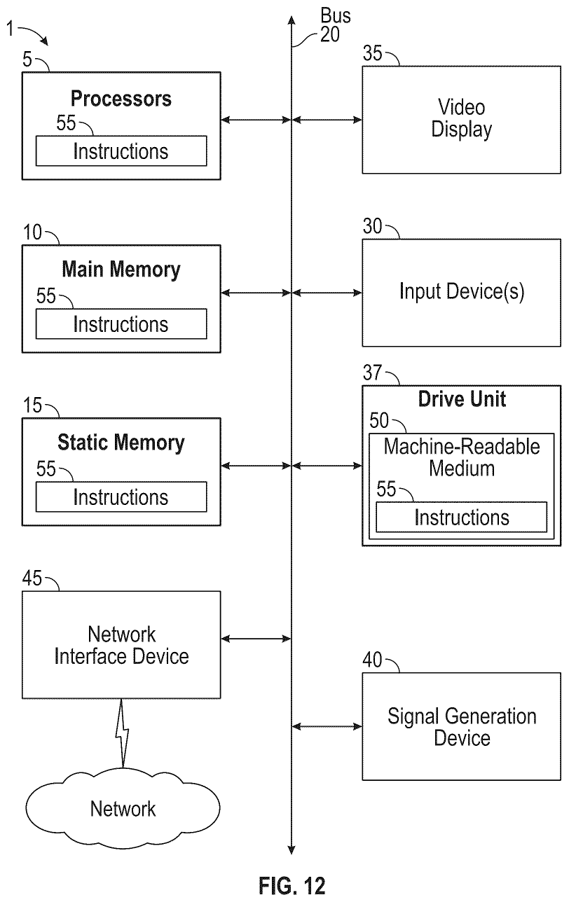

FIG. 12 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

### Rapid Bulk Recovery

The present disclosure further provides for embodiments that implement rapid bulk recovery of files that are affected or associated with a malicious event. The rapid bulk recovery of files addresses several problems when manual review of files by an administrator is required.

For instance, as previously described herein as in FIG. 10, the system can detect a malicious event, e.g., a cyberattack, a ransomware attack or a destructive attack where a user account or a machine address removes/deletes files or otherwise manipulates files. Upon detecting a malicious event, the system lists all the files that were affected or associated with the malicious event. The objective is then to remove the destroyed or manipulated file and replace it with a known “good” file that existed prior to the malicious event. Also, as described earlier herein and specifically as set forth in FIG. 10, based on certain information analyzed by the system, the system identifies a list of all the files that were associated with the malicious event. The system then provides a graphical user interface that allows for the restoration of the files from the immutable backup copy of the file system, so that files are restored as requested, as described earlier herein and depicted in FIG. 10.

Using the method as earlier described in FIG. 10, the administrator is required to manually select which files to remove (because they were destroyed or manipulated) and which files should be recovered from the immutable snapshot. Manual selection of files by an administrator, particularly when the files are numerous, can be time-consuming and inefficient. In other words, the longer the downtime, the longer is the time period during which the system is unable to provide users with the right version of data. In other words, users suffer data availability issues, when manual selection of files that are associated with the malicious event is required.

Thus, ideally, it is best to recover from a malicious event or incident as quickly as possible, such that the recovery time objective (RTO) is as low as possible. With this in mind, in some embodiments, a rapid bulk recovery process is key to keeping RTO as low as possible, since the rapid bulk recovery process can rapidly return the file system to the pre-attack state more quickly than if an administrator had to manually review multiple different versions of the numerous files in order to correctly restore the files that were affected by the malicious event.

A rapid bulk recovery process refers to the system's ability to identify which files associated with malicious event to remove and which files to restore, generate recommendations for an administrator regarding these files, and present a graphical user interface that displays the system's recommendations. With a couple of button clicks, the administrator can respond to the system's recommendations, thereby initiating the removal and/or recovery of the one or more files that are associated with the malicious event.

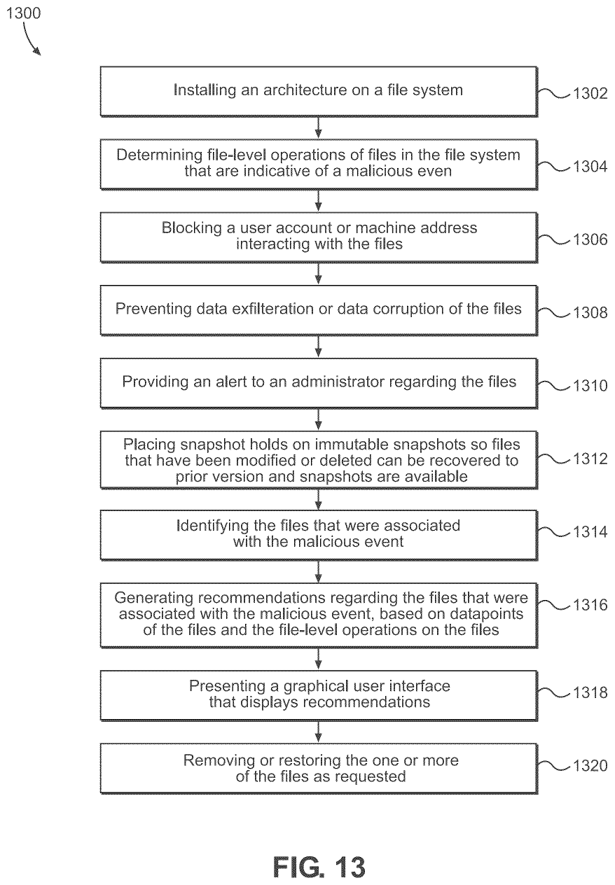

FIG. 13 is a flowchart of an example method 1300 of the present disclosure for providing cybersecurity active defense and rapid bulk recovery. The method 1300 can be performed by a system, such as the exemplary systems depicted in FIGS. 1 and 12. The method 1300 can include a step 1302 of installing or enabling a microservices architecture on a file system. As noted previously, the microservices architecture is configured to protect the file system in a zero trust manner from a malicious attack by a source system. The method 1300 can also include a step 1304 of determining file-level operations of files in the file system that are indicative of a malicious event.

The method 1300 further includes a step 1306 of blocking a user account or machine address interacting with the files, as well as a step 1308 of preventing data exfiltration or data corruption of the files. According to some embodiments, the method 1300 can include as step 1310 of providing an alert to an administrator regarding the files.

The method 1300 includes a step 1312 of placing snapshot holds on immutable snapshots so that files that have been modified or deleted can be recovered to prior versions and snapshots are available. The method 1300 also includes a step 1314 of identifying the files that were associated with the malicious event.

Also, the method 1300 provides a step 1316 of generating recommendations regarding the files that were associated with the malicious event, based on datapoints of the files and the file-level operations on the files. As used throughout the present disclosure, the term “datapoint” may be any information or aspect about a file. For instance, a datapoint can be any discrete information about the contents of a file, a parameter of the file, or it can be information of a file operation that is performed on the file. In some embodiments, the datapoints include a client IP address associated with a file operation, an account security identifier (SID) or username associated with the file operation, a file time stamp, and a file operation type. In some embodiments, for each file operation, the system captures the client IP address and an account SID or username that was associated with a file operation. The system may also capture a file time stamp associated with the file operation. A file operation type may be a read operation, an open operation, a write operation, a delete operation or any other allowable operation by the file protocol. The file operation type can be determined by the system (such as the system depicted in FIG. 1)

In further embodiments, the datapoints of a file that are the basis of the generating of recommendations include, but are not limited to one or more of a file path, a file name, an operation offset and size, a destination file name (for renaming), a protocol, a per-file detection timestamp derived from replay, a file creation timestamp, a file modification timestamp, contents from the active file system, changes in the file contents that are retained snapshots (rolling and periodic) taken prior to a detection of a malicious event or attack, and any combination thereof.

The recommendations generated by the system (such as the BSP system described earlier herein and depicted in FIG. 1) may include recommendations about which files should be removed from the active file system, as well as recommendations as to which files and file versions should be restored or recovered from the immutable snapshots of the file system.

In some embodiments, the recommendations generated by the system include a recommended list of the one or more files to be deleted from the file system. In other embodiments, the recommendations include a recommended list of the one or more files to be restored from the immutable snapshots of the file system. In yet further embodiments, the recommendations include both a recommended list of the one or more files to be deleted from the file system and a recommended list of the one or more files to be restored from the immutable snapshot of the file system. Further details about these system recommendations will be provided later herein.

In some embodiments, the method includes a step 1318 of presenting a graphical user interface (GUI) that displays the recommendations to the administrator regarding the files that were associated with the malicious event. Based on the administrator's user input via the GUI in response to the system recommendations, removal of one or more of the files from the active file system, and/or restoration of one or more of the files from an immutable backup copy of the file system or snapshot, is allowed. In some embodiments, the administrator's user input to the system recommendations is input by way of a single click or a couple of clicks via the GUI. Then, at step 1320, removal or and of the one of more of the files occurs, as requested by the administrator via the presented GUI.

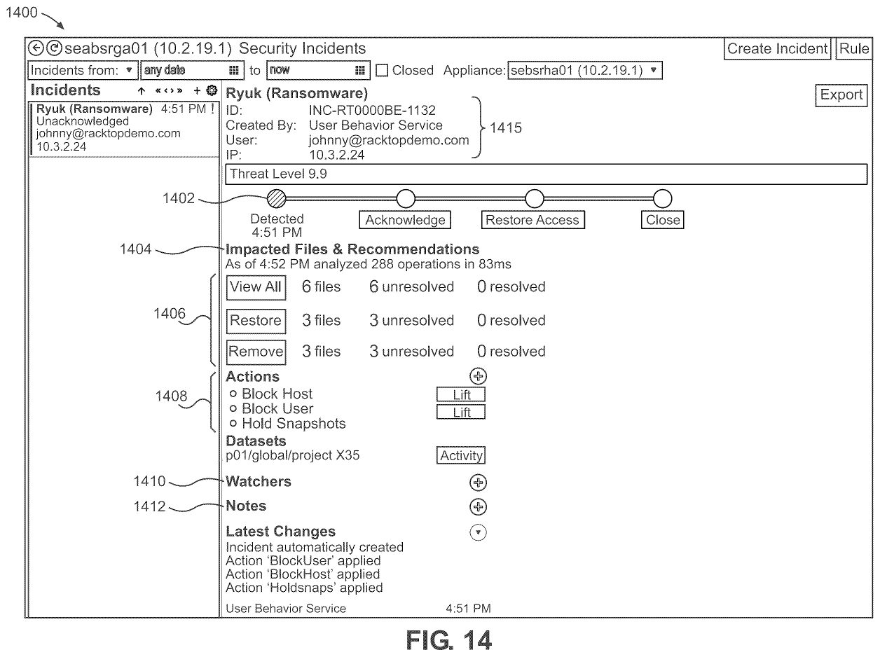

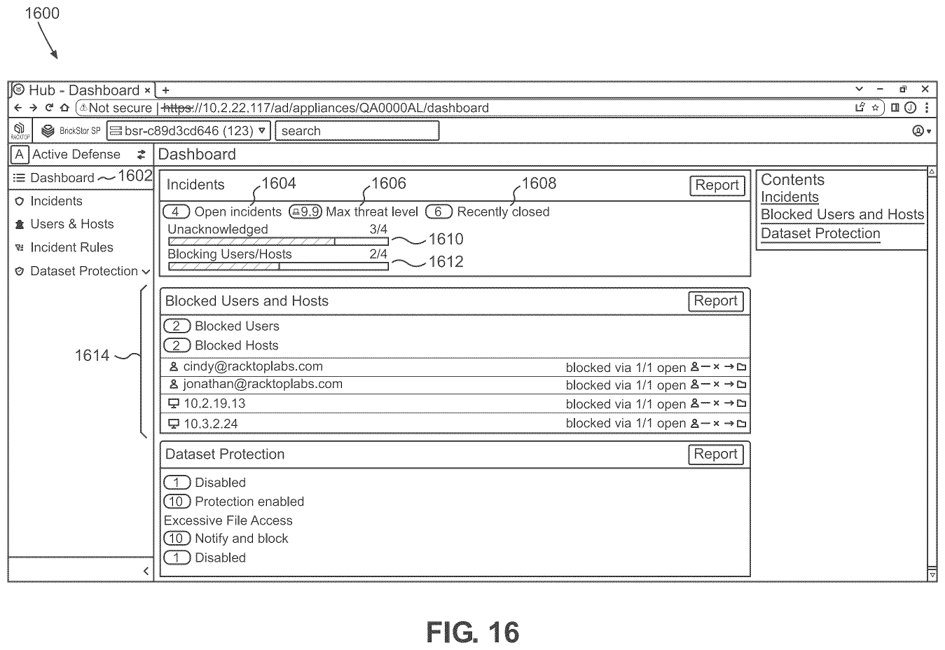

Exemplary GUIs that may be presented to the administrator in step 1318 will be described later herein, including the GUIs provided in FIGS. 14-20. Specifically, in some embodiments, the GUI includes a new incident dashboard that displays a number of incidents that are open, a number of incidents that are unacknowledged, and a number of incidents that were recently closed. An example of a new incident dashboard is provided in FIG. 16, which will be described in greater detail later herein.

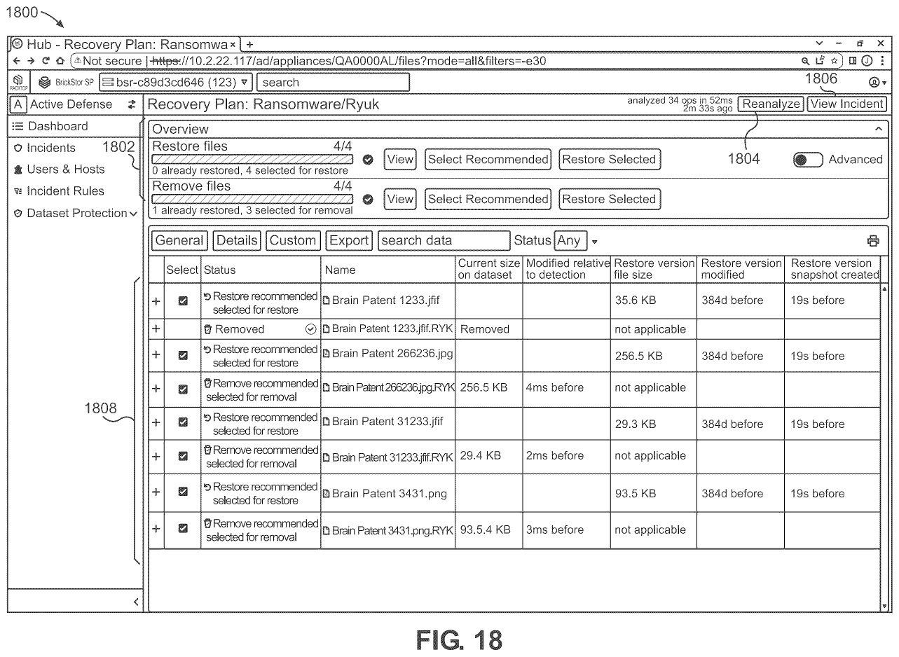

In other embodiments, the GUI provides a combined bulk recovery list. The combined bulk recovery list includes recommendations of the one or more files to be deleted from the file system and recommendations of the one or more files to be restored from the immutable backup copy of the file system. An example of a GUI having a combined bulk recovery list is provided in FIG. 18, which will also be described in greater detail later herein.

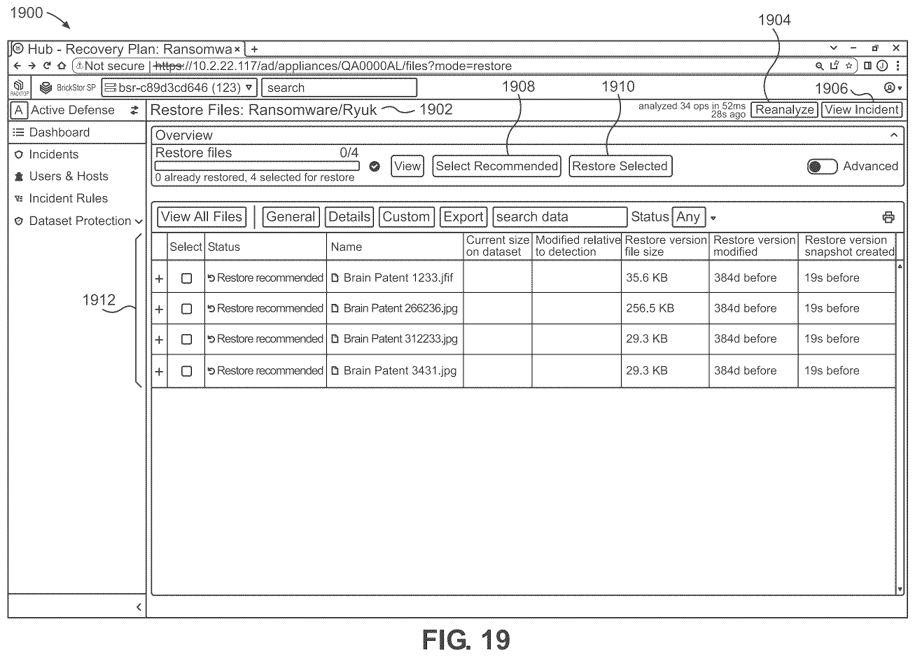

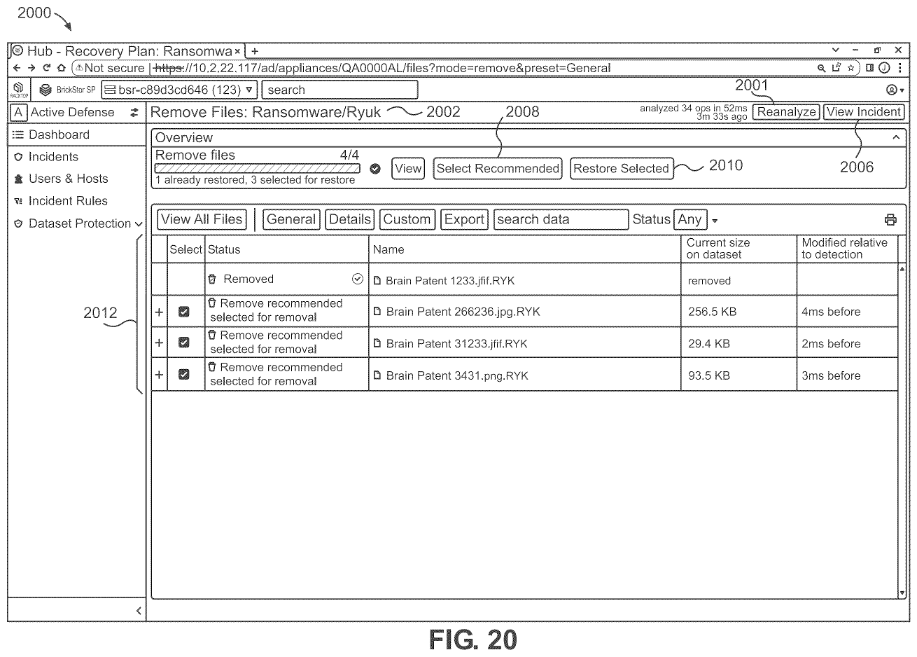

In yet other embodiments, the administrator is presented with a GUI that provides a divided view. The divided view includes a first view and a second view. The first view is configured for receiving the administrator's user input requesting a restoration of the one or more files from the immutable backup copy of the file system or snapshot. The second view is configured for receiving the administrator's user input requesting a deletion of the one or more files from the file system. Examples of a GUI having a divided view are provided in FIGS. 19 and 20, which will also be described in greater detail later herein.

It will be understood that the order of the steps disclosed in the various methods herein are not intended to be limiting, unless specifically claimed as such. Thus, various steps can be omitted or their order of operations rearranged as would be apparent to one of ordinary skill in the art.

In some instances, the method 1300 includes determining a real-time stream of user activity related to the file system, which captures datapoints of files, including an identity, a client/source IP address, and a protocol. In other instances, the method 1300 includes performing AI-based replays and conducting re-analyses of existing data by assessors for heuristic learning. In some embodiments, the method 1300 further includes utilizing real time parallel stream analysis so that client activity and security analysis operations occur concurrently.

In some embodiments, the system analyzes the files by inspecting and determining the last time a given file was modified, and also determining who modified the file. In other words, the system determines whether a suspected compromised account or attacker modified the file. Thus, the system determines which user or IP address accessed or otherwise modified a file, and then the system analyzes what happened to the file by reviewing what was modified in the file.

In some embodiments, the system looks back and reviews a previous version of a file that the system holds in an immutable snapshot. In other words, the system keeps snapshots, in order to inspect and determine which version(s) of a file exist and which version was the last one in time prior to the malicious event or attack. A threshold can be set by a system user or administrator, so that the system will inspect all the versions of a file that were stable for the time period set by the threshold (typically one minute or five minutes) before the time that the malicious event or attack occurred or the time that the malicious event was detected. With this information, the system can analyze and make recommendations to the administrator as to whether a file should be removed from the active file system or recovered/restored from the immutable backup copy of the file system.

The system may generate a list of all the files that are older than a given threshold (where the threshold can be one minute, 5 minutes, or any period of time) and then the system will present all the versions of those files in a GUI to the administrator. By default, the system reviews snapshots that are 5 minutes and older (based on a 5-minute threshold). That being said, the threshold can be changed from 5 minutes to 1 minute and then the system will re-analyze which files were changed around the time of the malicious event or attack.

In some instances, the system inspects, reviews or otherwise analyzes the name or IP address of a user account that accessed/modified a file, the dates and times that the file was modified, and details of the malicious event.

As previously described, the BSP system (100 of FIG. 1) implements a number of features in order to provide a robust cyberattack active defense. One such feature is known as the recovery and recommendation engine. The recovery and recommendation engine is essential for the rapid bulk recovery process, which is described in greater detail as the exemplary method 1300 of FIG. 13.

As one skilled in the art would know, certain attack types require multiple file operations to detect that a malicious event or attack is occurring, due to the methods and algorithms of the malicious event or attack. That is, some ransomware, excessive delete attacks, and overwrite attacks can take time for AI and heuristics to detect, block, and hold immutable snapshots.

In order to address this problem, the BSP system captures all the file events (that is, the raw activity) which is recorded, audited and analyzed by the different assessors in parallel. As mentioned earlier herein, the BSP system 100 proactively protects unstructured data in the file storage system 108 using inline real time assessors that look for or detect malicious and abnormal file activity conducted by a user or an application.

Once an attack is detected, the BSP system replays all the audited activity through an analyzer or assessor in a mode where an attack has been set to true. The assessors and AI algorithms look through or analyze the raw data again, to ensure that all malicious events are detected. The analyzer or assessor of the BSP system (such as the assessor 125 as depicted in FIG. 1) uses data derived from this replay, in order to generate recommendations to the user/administrator through the bulk recovery screens in a graphical user interface as to which files should be restored and which files should be removed. Exemplary GUIs depicting the bulk recovery screens are provided later herein.

As previously discussed, recommendations by the system are based on multiple datapoints. Specifically, exemplary datapoints that the recovery and recommendation engine of the system may use, in generating and providing bulk removal and restore recommendations to the administrator through a GUI, include but are not limited to the following:
File Event Records—Each with Client IP address, Account SID/username, File Operation Type (Ex: Read, Open, Write, Delete), File Path, File Name, Operation Offset and Size, Destination File Name (for rename), Protocol, Operation Timestamp
Per-file detection timestamp by an analyzer or assessor. The per-file detection timestamp is calculated by looking at multiple file event records per file by the replay of raw data, to determine a single detection timestamp for each file. There are also other metadata associated with file operations.
File creation/modification timestamps and contents from the active file system
Changes in file contents retained in snapshots (rolling and periodic snapshots) which were taken prior to a detection of the malicious event by the system
Consideration of files that may have already been recovered out of band
   One or more of the datapoints listed above may be used by recovery and recommendation engine of the system to generate and provide bulk removal and restore recommendations, as described in greater detail earlier herein regarding step 1316 of FIG. 13.

In some embodiments, the datapoints are collectively used to ensure that each file is restored to a last known “good” version captured in snapshot(s) taken prior to the file system being infected. This minimizes the loss of legitimate changes to files that were made just prior to the malicious event or attack. Audit records may be kept indefinitely by the system with the associated file data.

The active defense system described herein also uses custom AI models called assessors (see, for example, assessors 125 of FIG. 1). As new assessors are added to the active defense system, they can replay and re-analyze existing data to learn from prior attacks and leverage for future detection. In other words, in some embodiments, the system includes assessors for performing AI-based replays and conducting re-analyses of existing data for heuristic learning about detection of malicious events.

The active defense system also uses real time parallel stream analysis to allow both client activity and security analysis operations to happen concurrently. The active defense system includes a real time parallel stream analysis module to implement this. The real time parallel stream analysis is a significant advantage over an inline processing approach. This is exponentially advantageous over an external store and forward approach (i.e., callbacks to external systems, log shipping to a SIEM), which would slow down and negatively impact client data activity. Real time stream analysis is accomplished by splicing (which is also called tapping or teeing) metadata elements from live activity into a stream processor of the system, which then uses a shared memory architecture to allow internal but disparate processes to analyze streams in parallel and independently make decisions based on their own AI models. Results are concurrently and continuously aggregated and into an incident workflow upon malicious activity detection.

As mentioned earlier, the BSP system captures all the file events (that is, the raw activity) which is recorded, audited and analyzed by the different assessors in parallel. With the raw record format, the BSP system can store data effectively and the raw record format can be used for training data in long term analysis. In other words, the system can collect raw activity up front, and then analyze data after the malicious attack has occurred, in order to replay raw activity through the analyzer or assessor, knowing that there has been an attack. The system will review or look at prior snapshots to determine what are the best files to recover. Furthermore, the system will perform an AI-based replay after a known malicious attack to determine which files to recover. The system can also store event data indefinitely in an efficient record format.

One of the parallel streams for client activity aggregates, processes and transforms data into file activity records which are stored on a non-volatile media in files grouped by access times and stored in a binary encoded format optimized for streaming from physical media. A processed activity database of the BSP system maintains an on-disk index of activity fields, and an additional in memory record locator index, such that any record or collection of records can be quickly accessed without directly reading the individual activity files themselves. For example, activity files will normally have millions of records, but the composite on-disk plus in memory index allows those millions of records to be processed in seconds with low memory footprint. New records are appended to the end of files that are bucketed by day. The database supports parallel readers while a writer appends new records.

The readers use a highly optimized record decoder that reuses memory when processing each record to minimize per record memory allocations. In many cases, processing each record does not require any additional memory allocations. When analyzers or assessors (such as the assessors 125 of FIG. 1) need to retain specific metadata for historical analysis, the memory required is deduplicated with history stored prior. This allows analyzers to process operations and maintain a low memory footprint. By not allocating per record memory the application does need to spend CPU cycles detecting and releasing unused memory. The writer appends records to the end of files that have been organized and bucketed by day. Multiple file operations are merged into a single record to reduce overhead when the individual operations are contiguous and not mixed with other operations to the same file. This can result in a single record when a client reads a large file that requires multiple contiguous read operations to complete. The database maintains an index of metadata about each day and records within each file including operation counts and timestamp range. This enables files to be skipped based on timestamp criteria when processing historical data. Processed activity files are fully transportable and are not distinct to the source system.

In further embodiments, the system provides a dashboard which illustrates two types of incidents, namely, notifications for unusual events and for actual attacks. As a result, the dashboard provides incident bifurcation. Unusual events are anomalous behavior, such as the use of a weak protocol or other potentially interesting behaviors. The system will auto-remediate and close these notification incidents after 24 hours. Attack incidents are for activity where an attack event is detected. These events will not auto-remediate and must be managed by a system administrator.

The system also includes an improvement of an assessor/analyzer (such as the assessors 125 of FIG. 1) in that the sensitivity level for the analyzer can be adjusted. Valid settings are “normal,” “reduced”, “low” and “off”. This can be used during initial deployment, or when the usage of the system has changed, to reduce false positives and prevent disruption of service to the clients. Instead of blocking users, only a notification incident would be created, which provides awareness to the administrator for any custom rules that will need to be created for typical activity under the “normal” sensitivity.

In addition, active defense can be suspended on a dataset for a period of time, if there will be known activity which should not be saved or analyzed, such as a bulk data load. This can be scheduled in advance with a start and end time. Generic exfil ransomware assessor (also known as extortionware) analyzes the pattern of activity that exfiltrates files and leaves a ransom note. A custom assessor is not required for each type of extortionware.

The processed activity database records from many systems (sources) can be aggregated together on a third system(s) to allow for continuous recursive training of the active defense assessor models. The recursive training and analysis (RTA) comprises one or more services which perform the aggregation and storage of processed activity, and provide an interface (API) for other components of the active defense services to on-demand query, re-train, and improve their decision models based on lifetime client activity. The UB store is for a persistent record of activity that can be searched and reviewed. It is also used for incident recovery and reporting.

The system also can turn off activity collection per dataset, which eliminates unnecessary records and provides better efficiency by eliminating records which do not need to be analyzed or saved, which in turn equates to records collection and analysis efficiency. The administrator can disable the analyzer from processing certain folders and file name patterns.

Client activity can come into the system at a higher rate than active defense can consume the activity records. Normally the entire service runs at full speed, but when it detects that it is falling behind, it applies backpressure which propagates back to the clients and slows down incoming activity. This dynamically adjusts until equilibrium has been achieved. Once the load has slacked off, the system dynamically adjusts to return to full speed. This applies to any client protocol such as NFS or SMB. The active defense system does not run in-line with protocol handling. This allows the protocols to run at full speed while the system sits on the side to analyze the records. Latency is not added since the system provides the analysis out of band but can still apply backpressure when necessary.

Referring now to FIG. 14, FIG. 14 depicts a screenshot of an exemplary graphical user interface (GUI) 1400 concerning a security incident (also known herein an incident). FIG. 14 indicates that the security incident is a ransomware incident, and a timeline 1402 is shown regarding the status of the security incident. Based on the timeline 1402, FIG. 14 illustrates that the security incident was detected at 4:51 pm. Still referring to the timeline 1402, the timeline 1402 further indicates that the security incident has not yet been acknowledged, access has not yet been restored, and the security incident has not yet been closed.

The GUI 1400 also includes an impacted files and recommendations section 1404, which in the example provided in FIG. 14, indicates that there are six total unresolved files. Specifically, the impacted files and recommendations section 1404 shows how many total files were affected in the security incident, how many files need to be restored from a snapshot, and how many files should be deleted from the active file system. Once the rapid bulk recovery process is complete, the impacted files and recommendations section 1404 will show that all the files are resolved.

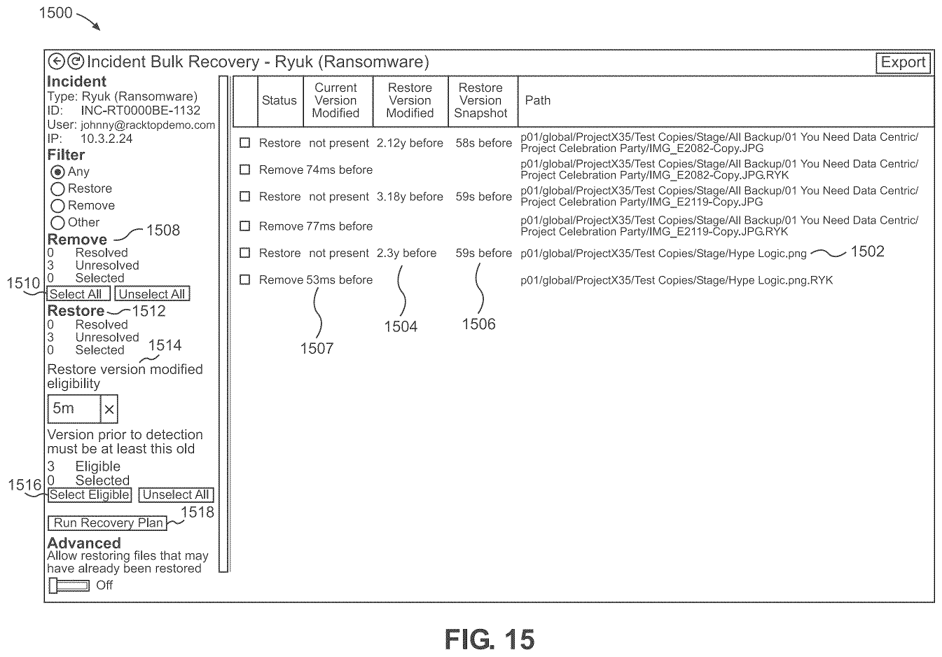

Still referring to the example provided in FIG. 14, for those six total unresolved files, in the recommendations 1408, the system recommends restoring 3 files and removing 3 files of the six total unresolved files. The recommendations 1408 generated by the system are part of the rapid bulk recovery process described herein. As explained earlier, the recommendations 1408 are based on particular datapoints of the files associated with the malicious event (in this case, the ransomware attack). The system has determined that the 3 files recommended to be removed 1406 based on the datapoints and analysis of the assessor. The user can click on the View All button in 1406 to get to a view of GUI 1500 (FIG. 15). The datapoints in this incident FIG. 1500 shows that three files were overwritten in less than a second prior to incident discovery, and that these files were overwritten from file operations performed by the same user, 1415 johnny@racktopdemo, and client IP, 10.3.2.24. FIG. 1500 shows the three specific files that are recommended to be removed which in this case are the renamed and encrypted versions of the previous files. To fully recover from the incident, the GUI 1500 shows files that it recommends restoring to replace the encrypted version of the file, the file manipulated in the attack. The system implicated these files with file operations in the attack with the user account, client IP, file operations on the files, and the timestamp for the events. For example, one of the three files GUI 1500 recommends for file restoration shows that the recommended version to restore for file Hype Logic.png 1502 had not been modified for 2.3 years 1504 before the cyberattack incident. This means the version of the file was stable for well over 5 minutes prior to the attack 1514. The GUI 1500 shows the user that version of the file is available in the snapshot from 59 seconds prior to the incident 1506 and recommends the user restores that version of the file from that snapshot to the live file system. This will restore the file to the pre-attack version of the encrypted file.

The GUI 1400 also includes an actions section 1408, by which an administrator can block or unblock a host, block or unblock a user, or hold snapshots. The GUI 1400 also provides a means for an administrator to add watchers who will be notified about latest changes in and actions for the incident. Furthermore, the GUI 1400 includes a notes section 1410, in which a person managing the security incident can add notes. Finally, the GUI 1400 includes a section that shows the latest changes and actions for the incident, which will be sent via webhooks and to the watchers as changes and actions occur.

FIG. 15 depicts a screenshot of an exemplary GUI 1500 of bulk recovery in response to the security incident described in exemplary GUI 1400 of FIG. 14. Still referring to FIG. 15, the GUI 1500 shows a list of six total unresolved files (which were mentioned in the description of FIG. 14). The GUI 1500 also provides specific details of each of those six unresolved files, including a file path 150. Referring now to the fifth unresolved file provided in the list of files depicted in the GUI 1500, the system shows a recommendation of “Restore” and the GUI 1500 further shows a restore version modified field 1504 of “2.3y before”. In other words, the restore version modified field 1504 shows that this particular file was not modified for 2.3 years before the incident. Also, the GUI 1500 provides a restore version snapshot field 1506, which for this particular file shows that the file was changed 59 seconds before the incident was detected. These two file modification timestamps provided in the restore version modified field 1504 and the restore version snapshot field 1506 are datapoints that the system uses in generating the recommendation that this particular file be restored from the immutable backup copy of the file system.

The GUI 1500 also shows that for the last file provided in the list of six total unresolved files, the system provides a recommendation 1507 of “Remove 53 ms before.” This means that for this last file, Hype Logic.png.RYK, the system recommends removing the file that is present on the live file system and was modified 53 milliseconds before the system detected the malicious event and opened an incident.

The GUI 1500 also includes Remove section 1508 and Restore section 1512. The Remove section 1508 indicates how many files recommended for removal from the active file system are resolved, unresolved and selected by the administrator. The Remove section 1508 also includes a Selection all button 1510, which allows the administrator to select all the files recommended by the system to be removed from the active file system. In this case, those files recommended for removal are encrypted ones. Similarly, the Restore section 1512 indicates how many files recommended for restoration are resolved, unresolved and selected by the administrator.

The GUI 1500 also has a drop-down menu 1514 whereby the administrator can set a threshold based on time. In the GUI 1500, the drop-down menu 1514 currently shows 5 m which refers to a threshold of 5 minutes. In other words, by setting the threshold to 5 minutes, the system will analyze and provide a list of all versions that were modified more than five minutes before the security incident occurred or was detected. It will not recommend any file versions within 5 minutes of incident detection for restoration. The threshold can be changed from 5 minutes to other thresholds, such as 1 minute or 10 minutes.

The GUI 1500 includes a Select Eligible button 1516. If the Select Eligible button 1516 is clicked, the system will select the files and the versions of those files recommended to restore from the snapshots. The GUI 1500 further includes a Run Recovery Plan button 1516. When clicked, this single Run Recovery Plan button 1516 will cause the system to run a recovery plan which will restore and remove selected files.

FIG. 16 depicts an exemplary GUI 1600 which includes a new incident dashboard that displays a number of incidents that are open, a number of incidents that are unacknowledged, and a number of incidents that were recently closed. This dashboard is provided when the Dashboard tab 1602 is selected. An open incidents field 1604 of the GUI 1600 provides the number of incidents that are open. A max threat level field 1606 indicates the level of the maximum threat provided by the incidents. A Recently closed field 1608 provides the number of incidents that were recently closed. An Unacknowledged progress bar 1610 shows the number of incidents that are acknowledged. Specifically, in the example provided in the GUI 1600, the Unacknowledged progress bar 1610 shows that 3 of 4 open incidents are unacknowledged. Further, a Blocking Hosts/Users progress bar 1612 shows how many hosts or users are currently being blocked. In the example provided in the GUI 1600, the Blocking Hosts/Users progress bar 1612 shows that 2 of 4 hosts/users are currently being blocked. The specific blocked hosts/users are detailed in the Blocked Users and Hosts section 1614 of the GUI 1600.

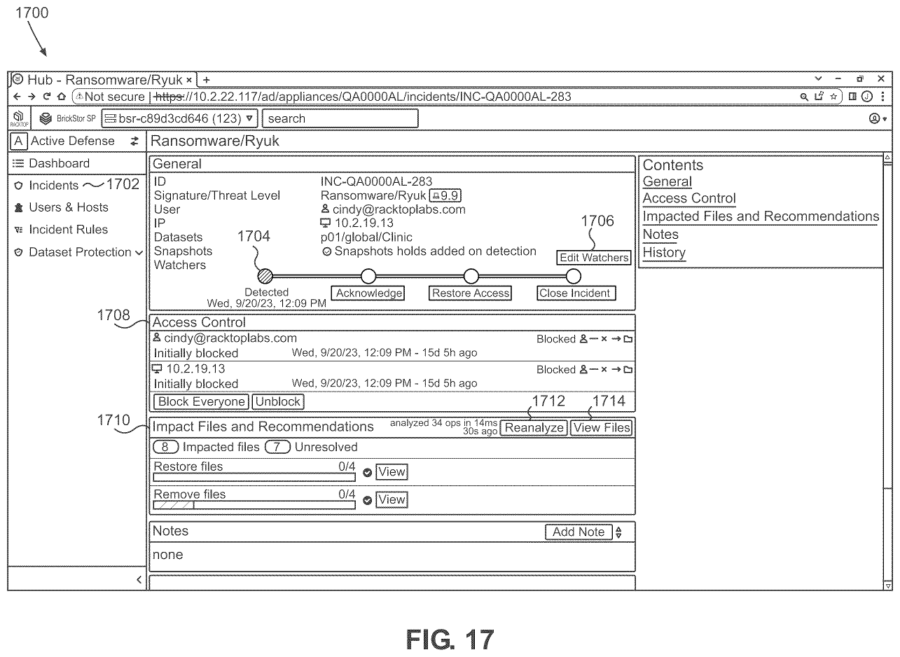

FIG. 17 depicts an exemplary GUI 1700 which illustrates a new incident management page which is provided when the Incidents tab 1702 is selected. FIG. 17 indicates that the security incident is a ransomware incident, and a timeline 1704 is shown regarding the status of the security incident. Based on the timeline 1704, FIG. 17 illustrates that the security incident was detected at 12:09 pm on Wednesday Sep. 20, 2023. Still referring to the timeline 1704, the timeline 1704 further indicates that the security incident has not yet been acknowledged, access has not yet been restored, and the security incident has not yet been closed.

The GUI 1700 includes an edit watchers button 1706 which allows an administrator to edit a list of watchers that are notified of the latest changes and actions in the incident. The GUI 1700 also includes an Access Control section 1708, which details which users and/or hosts were blocked by the system. The Access Control section 1708 also includes buttons that allow the administrator to block or unblock everyone listed in the Access Control section 1708.

The GUI 1700 also includes an impacted files and recommendations section 1710, which in the example provided in FIG. 14, indicates that there are 8 impacted files (files that were impacted by the incident) and 7 files that remain unresolved. Specifically, the impacted files and recommendations section 1710 shows how many total files were affected in the security incident, how many files are recommended for restoration from a snapshot, and how many files are recommended for deletion from the active file system. Once the rapid bulk recovery process is complete, the impacted files and recommendations section 1710 will show that no files remain unresolved (that is, all files are resolved).

The impacted files and recommendations section 1710 further includes a Reanalyze button 1712, which when clicked will cause the system to reanalyze the raw data as described herein and generate recommendations regarding the impacted files. The impacted files and recommendations section 1710 also includes a View files button 1714, which when clicked will cause the system to display the impacted files to the administrator.

FIG. 18 depicts a GUI 1800 that includes a combined bulk recovery list. The combined bulk recovery list is provided in an overview 1802, which lists the number of files recommended by the system for deletion and provides the number of files recommended for restoration. The overview 1802 also provides buttons for the administrator, in order to respond to the recommendations generated by the system. The administrator may click one of the two Select Recommended buttons, which will cause the system to select the recommended files for either deletion or restoration. Likewise, the administrator may click on the Remove Selected or Restore Selected buttons, which will cause the system to remove or restore the selected files, respectively.

The GUI 1800 further includes a Reanalyze button 1804, which when clicked will cause the system to reanalyze the raw data as described herein and generate recommendations regarding the impacted files. The GUI 1800 also includes a View incident button 1806, which when clicked will cause the system to display the incident dashboard (such as the dashboard depicted in FIG. 16) to the administrator.

Finally, the GUI 1800 provides a list of impacted files 1808, including recommendations and details of certain files to be deleted from the file system, as well as recommendations and details of certain files to be restored from the immutable backup copy of the file system.

FIGS. 19 and 20 collectively depict GUIs 1900 and 2000 that offer a divided view to an administrator. The divided view includes at least a first view and a second view. The first view is configured for receiving the administrator's user input requesting a restoration of the one or more files from the immutable backup copy of the file system or snapshot. The second view is configured for receiving the administrator's user input requesting a deletion of the one or more files from the file system. In other words, the view has been divided in FIGS. 19 and 20, such that the administrator can request the system to perform restorations in the first view and the administrator can request the system to perform deletions in the second view. The administrator can switch from the first view to the second view and vice versa, for more control.

Specifically, in FIG. 19, the GUI 1900 provides a first view for restoring files as shown by a Restore Files header 1902. The GUI further includes Select Recommended button 1908, which will cause the system to select the recommended files for restoration. The administrator can click on the Restore Selected button 1910, which will cause the system to restore the selected files. The GUI 1900 further includes a Reanalyze button 1904, which when clicked will cause the system to reanalyze the raw data as described herein and generate recommendations regarding the impacted files. The GUI 1900 also includes a View incident button 1906, which when clicked will cause the system to display the incident dashboard (such as the dashboard depicted in FIG. 16) to the administrator. The GUI 1900 provides a list of files recommended for restoration 1912, including details of the files to be restored from the immutable snapshot of the file system.

In FIG. 20, the GUI 2000 provides a second view for removing files as shown by a Remove Files header 2002. The GUI further includes Select Recommended button 2008, which will cause the system to select the recommended files for removal. The administrator can click on the Remove Selected button 2010, which will cause the system to remove the selected files from the active file system. The GUI 2000 further includes a Reanalyze button 2001, which when clicked will cause the system to reanalyze the raw data as described herein and generate recommendations regarding the impacted files. The GUI 2000 also includes a View incident button 2006, which when clicked will cause the system to display the incident dashboard (such as the dashboard depicted in FIG. 16) to the administrator. The GUI 2000 provides a list of files recommended for removal 2012, including details of the files to be removed from the active file system.

It will be appreciated that the rapid bulk recovery processes described herein can be implemented utilizing the systems depicted in any of the accompanying figures, including but not limited to FIGS. 1 and 12. With the help of rapid bulk recovery processes, users can rapidly return the file system to the pre-attack state more quickly than if an administrator had to manually review versions of files in order to correctly and efficiently restore the files that were affected by the malicious event.

### Cybersecurity Active Defense for Files Stored on Third Party Storage Systems

The present disclosure provides exemplary embodiments that provide cybersecurity active defense at high speed for an end user's data that is stored on third-party storage systems (such as NAS) or other third-party products. There are numerous reasons why the present disclosure provides technical advantages over conventional systems. First, the present disclosure describes a security platform or a security system that provides inline data security in the data plane, and specifically, provides data-centric, zero-trust security in real time. The security system of the present disclosure sit between the end users and the actual third-party file storage systems, to provide data security capability and the active defense features (many of which are described earlier herein), without actually storing the data in the security system itself. Also, the innovative systems and methods described herein help to identify and stop anomalous behavior from accessing the data in real time. Further, the systems and methods herein allow for recovery from anomalous behavior in real time, thereby protecting third-party storage systems that do not have the same level of protection. In contrast to the present disclosure, conventional systems look at audit logs out of band and typically do so only after a cyberattack or incident has occurred.

Furthermore, the present disclosure does not require the data itself to be transferred to or stored on the security platform. Instead, the data stored on the third-party storage system can be accessed via the security platform by utilizing a rtfs overlay filesystem, all of which will be described in greater detail later herein. An example of the security platform is the BrickStor Security Platform (BSP) system (100 of FIG. 1) that was described earlier herein. The security platform may comprise an operating system. The security platform is positioned between the end users and third-party storage file systems (such as network-attached storage systems). Typically, third-party storage file systems share data over common protocols such as SMB or NFS. Hence, the systems and methods of the present disclosure provide data security capability and cybersecurity active defense, without actually storing the data in the security platform. Thus, the systems and methods of these embodiments are similar to what was described in FIGS. 1-20, but one of the main differences lies in the backend. Instead of writing files locally, the present disclosure includes systems and methods for obtaining or reading the files from local storage or reading them from a third-party storage system. Generally speaking, since the security platform sits in between the end user/client and the third-party storage system, an end user is unaware of the security platform. In other words, the security platform is transparent to the end user or the client. Furthermore, depending on the type of request made by the end user, whether the request is a file system operation or a directory listing operation, the security platform will proxy that to the backend, take the response from the backend, and transmit it to the end user.

Returning to the technical advantages of the present disclosure, additionally, it may be beneficial to the end user for their data not to be stored on the security platform. Some end users cannot store or migrate their data from the third-party storage systems to the security platform. For instance, an end user may find it technically impossible to do so, or it would require additional training for the end user to migrate their data to the security platform. Alternatively, it may be that the client is legally or contractually obligated to store their data on specific third-party storage systems or third-party products. The methods and systems described herein advantageously add a security layer onto the end user's data files to enhance security, while allowing the end user to continue using the-third party data storage platforms or products that are familiar to them.

Furthermore, the systems and methods of the present disclosure provide a security layer, with active defense features, for access to a third-party storage system (e.g., NAS). The security layer furnished by the security platform, such as the BSP system (100 of FIG. 1), initially mounts the third-party storage system. The third party providing the third-party storage system remains hidden, as it utilizes a private IP address. Thus, the only way for one to access the data from the third-party storage system is via the security platform.

Also, as will be evidenced in the disclosure provided later herein, the security platform provides a snapshot alternative to support incident recovery. This snapshot alternative provides yet another technical advantage of the present disclosure in that by using snapshots of artifacts, the systems and methods described herein identify what specific portion or portions of a changed file must be restored to its pre-change (also known as pre-image) state. In other words, the systems and methods do not require the restoration or recovery of the entire file; instead, advantageously, it is only the specific portions of the changed file that must be restored or recovered based on the information provided by the snapshots of artifacts. Thus, if the changed portion of the file is only one sentence or image, then that sentence or image will be restored or recovered, as opposed to the entire file being restored. This type of recovery therefore requires less system resources and it streamlines computational processes for file recovery.

Advantageously, the systems and methods of the present disclosure can also protect cloud storage. Thus, since snapshots of a previous version of a file cannot be relied upon when dealing with a third-party storage system (e.g., NAS), the systems and methods of the present disclosure can copy the file on the third-party storage system, rename it, and perform other operations which will be described later herein, such that the security platform can implement a recovery from a malicious activity against the file.

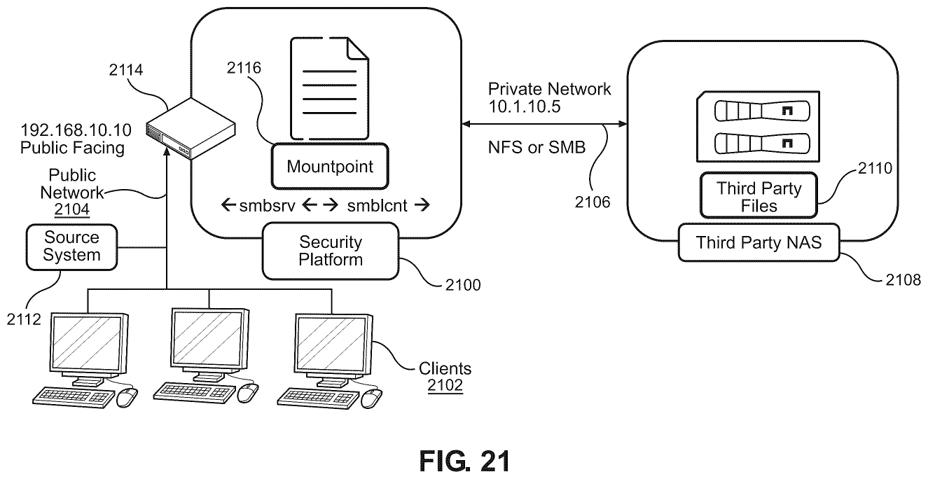

Furthermore, for certain operations that are intended for one or more files stored on the third-party storage system, the security platform will intervene. For instance, if the operation is a file write operation, the security platform will intervene and will save the “to-be-overwritten” extents locally onto the security platform, in case the operation is coming from a bad actor, such as a source system (e.g., the source system 2112 of FIG. 21).

Generally speaking, at that point, the computer system will analyze an operation and determine whether operation is a correct operation or a safe operation that is not from a malicious actor. The security platform will determine whether the operation matches one of the security threats and whether this is part of a ransomware attack.

In some embodiments, if the security platform determines that the operation or activity is malicious, then it will stop the operation from reaching the data on the third-party storage system. In some embodiments, the security platform will temporarily stop the operation or activity, in order to save copies of the data (using snapshots of artifacts) so that the data can be recovered if the need arises. The security platform will then pass the operation to the third-party storage system.

FIG. 21 illustrates an example architecture of a security platform 2100 (also referred to as a cybersecurity active defense security system), which is a protected storage system, one or more clients 2102, a public network 2104, a private network 2106, a third-party storage system (NAS) 2108, third-party files 2110, and a source system 2112. The public network 2104 can include combinations of networks. The public network 2104 can include both short and long-range wireless networks.

The one or more clients 2102 or users will be understood to refer to a system that is used to access data (e.g., the third party files 2110) from the third-party storage system 2108 via the security platform 2100 over the public network 2104. The source system 2112 is a computer or device where the malicious behavior is originating from. Some embodiments and use cases may refer to the use of S3 (Simple Storage Service protocol), SMB (server message block file sharing protocol) and/or NFS (network file system file sharing protocol).

In some embodiments, the security platform 2100 can include a security platform service (also known as a rtfs service), a client facing interface, and a device or appliance 2114. In general, the security platform 2100 can be configured to detect and stop insider threats and ransomware attacks.

Broadly speaking, the security platform 2100 provides a data-centric zero trust architecture with active defense and policy enforcement against unusual data access, ransomware, insider threats and excessive file access. As mentioned earlier herein, the active defense features of the security platform 2100 can immediately alert security and infrastructure teams about suspicious behavior as well as block the suspicious user accounts and IP (Internet Protocol) addresses from accessing further data. As it pertains to ransomware, the security platform 2100 can be configured to create a cyber resilient architecture that stops and contains the ransomware attack, automatically generate an incident report and allow other non-offending users and applications to access data and continue to deliver critical services. The built-in incident management features make it easy to determine the source of the attack and immediately restore files that were affected and return the system to service quickly.

The security platform 2100 proactively protects unstructured data in the third-party storage system 2108 using inline real time assessors that are looking for malicious and abnormal operations. The security platform 2100 can implement active defense mechanisms that are extensible and can tie into an organization's security ecosystem through webhooks and email alerts. In addition to detecting abnormal operations and employing a zero-trust evaluation model for file operations the security program 2100 can enforce a cybersecurity data policy and stop an attack in real time before it is too late.

By default, the security platform 2100 has assessors that detect, for example, operations or file access events such as reads, writes and deletes per data set. The security platform 2100 can also detect specific events, such as ransomware and/or another malicious event.

As depicted in FIG. 21, the security platform 2100 is communicatively coupled with the third-party storage system 2108. In some embodiments, an example of the third-party storage system 2108 is a Windows® File Service. The security platform 2100 mounts the third-party storage system 2108 using a file system driver. As will be described later herein, the file system driver intercepts operations and preserves pre-image states (which may also be referred to as pre-change states) from certain changes that are made to files on the third-party storage system 2108. In some embodiments, the file system driver includes a rtfs overlay driver and a rtfs_dev event publisher pseudo driver.

It should be noted that the security platform 2100 cannot simply snapshot the third-party storage system 2108 that has been mounted onto the security platform 2100. Instead, the security platform 2100 must journal operations (such as Deletes, Creates, or Writes operations), and Permissions, ownership, and ACL (Access Control List) changes. The pre-change state is preserved on the security platform 2100 and the security platform 2100 allows changes through to the third-party storage system 2108. The security platform 2100 then can rolling-snapshot the journal (also known as a journal entry) and later utilize the snapshots/journal to execute a recovery plan. Changes in file contents can be retained in snapshots (rolling and periodic snapshots) which were taken prior to a detection of the malicious event by the security platform 2100. Further details of this snapshot alternative recovery plan will be provided later herein.

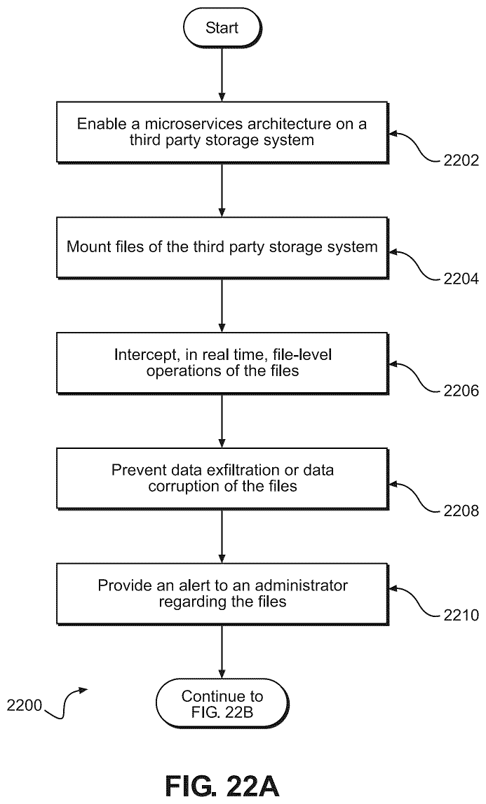

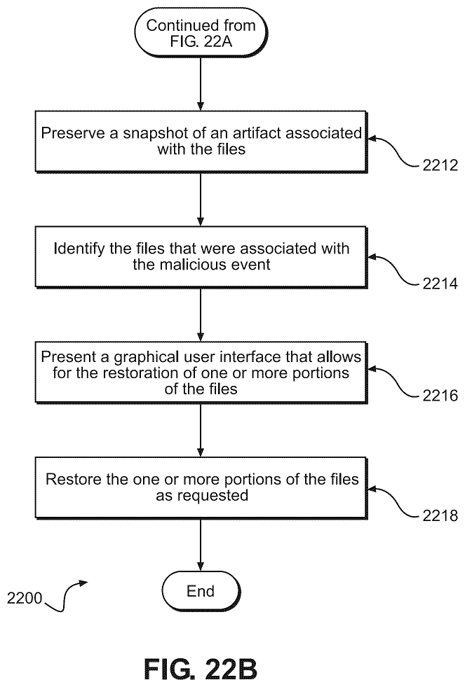

FIGS. 22A and 22B provide a flow diagram of an example method 2200 of the present disclosure. At step 2202, the method 2200 begins by enabling a microservices architecture on a third-party storage system (such as the third-party storage system 2108 of FIG. 21). As noted above, the microservices architecture is configured to protect the third-party storage system in a zero-trust manner from a malicious attack by a source system. At step 2204, the security platform (such as the security platform 2100 of FIG. 21) mounts files of a third-party storage system (such as a NAS) over a private network or a local network (LAN) using a protocol (such as SMB or NFS protocol), resulting in a mountpoint 2116 (FIG. 21) that resolves to a third-party storage system share. Upon implementing this, the files of the third-party storage system are now accessible and viewable by the security platform.

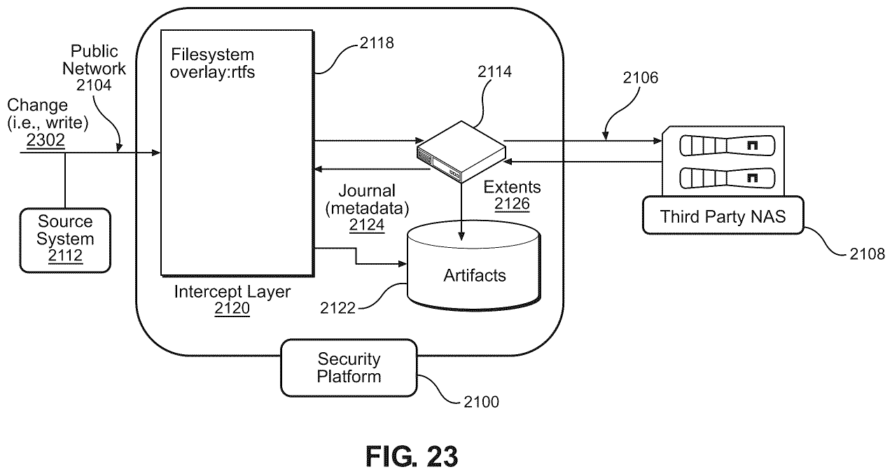

Each third-party mount has a corresponding dataset of the security platform. A dataset stores artifacts (such as artifacts 2122 of FIG. 23), which can include journals and extents. A dataset of the security platform is on a snapshot schedule for every minute. For instance, in some embodiments, the dataset retains five snapshots a minute. Over time, snapshots are dropped off and replaced by new snapshots.

For the greater network (such as the one or more clients 2102 of FIG. 21) to view the files of the third-party storage system, for the public facing side, a SMB server of the security platform republishes the files of the third-party storage system. The SMB server is positioned or sits in front of the mountpoint. The security platform service (also known as the rtfsd service) that provides services to the clients or end users will read events as they occur.

The method can also include a step 2206 of intercepting, in real time, file-level operations of the files in the third-party storage system in case they are indicative of a malicious event. Such file-level operations may include change operations, write operations, truncate operations, delete operations, or remove operations which will modify one or more portions of one or more files. The intercepting step 2206 may include substeps of creating journals (i.e., journal it), publishing journals with optional extent, and/or preserving one or more pre-image states of the files in the third-party storage system. These substeps will be described in greater detail later herein. The intercepting step 2206 may be accomplished by the overlay filesystem that comprises an intercept layer to preserve the one or more pre-image states of the files of the third-party storage system.

The method 2200 can include a step 2208 of preventing data exfiltration or data corruption of the files. According to some embodiments, the method can include a step 2210 of providing an alert to an administrator regarding the files.

The method 2200 can include a step 2212 of preserving a snapshot of an artifact associated with the files, so that one or more portions of the files that have been modified or deleted are recoverable to prior versions based on the snapshot, where the artifact comprises a journal of the malicious event. The artifacts of the files comprise at least a published journal of the malicious event, and in some embodiments, an optional extent. The method 2200 can also include a step 2214 of identifying the files that were associated with the malicious event. In some embodiments, the method includes a step 2216 of presenting a graphical user interface that allows for the restoration of the one or more portions of the files from the snapshots of the artifacts of the third-party storage system, and a step 2218 of restoring of the one or more portions of the files as requested. In addition, pre-restoration (i.e., potentially malicious) file data may be quarantined on the controller for later examination.

It will be understood that the order of the steps disclosed in the various methods herein are not intended to be limiting, unless specifically claimed as such. Thus, various steps can be omitted or their order of operations rearranged as would be apparent to one of ordinary skill in the art.

In some instances, the method may include a step of identifying file access events comprising reads, writes and deletes per data set, as well as identifying unusual file access events by a privileged account. One embodiment includes a step of identifying a ransomware event.

As mentioned earlier, one of the substeps of intercepting operations is creating journals. FIG. 23 is an example architecture for file activity journaling to intercept changes (or change operations that will change a file) and create artifacts. In FIG. 23, the source system 2112 or a client (such as one or more clients 2102) sends a change (i.e., write) operation intended for a file on the third-party storage system 2108. The change operation is transmitted via the public network 2104 to the security platform 2100. The security platform 2100 comprises a rtfs overlay filesystem 2118 that intercepts file operations, such as the exemplary change (i.e., write) operation depicted in in FIG. 23. The rtfs overlay filesystem 2118 provides an intercept layer 2120 which stops and determines whether a given file operation (in this case, the change operation) is a security threat or is malicious.

The rtfs overlay filesystem 2118 publishes a journal (metadata) 2124. The journal 2124 records what has changed and how it changed. That is, the journal 2124 comprises thin/metadata and it is a record of the change being made. If available, the device or appliance 2114 of the security platform 2100 obtains an extent 2126 from the third-party storage system 2108. The extent 2126 is a range of existing third-party data at an offset. An extent is preserved to allow recovery, and it comprises heavy/binary data. The current limit of an extent is 1 MB.

An artifact is an append-only forensic record of change activity. The artifact comprises the journal 2124 and optionally an extent 2126.

To create an artifact, the rtfs overlay filesystem 2118 of the computing system intercepts a change (i.e. VOP_WRITE) operation. One or more artifacts are created by the rtfs overlay filesystem 2118 using these steps:
a. A journey entry 2124 is prepared.
b. If indicated, the device or appliance 2114 associated with the security platform 2100 obtains the to-be-overwritten data from the mountpoint (2116 of FIG. 21).
c. A journal 2124 and optional extent 2126 are written to an in-kernel ring buffer.
   The underlying vop (i.e., smbfs_write) is called. Also, a rtfs_dev—pseudo driver exposes a read endpoint for the ring buffer.

For artifact creation, from the point of view of the rtfsd of the security platform 2100, the main loop is always reading rtfs_dev. It reads an “event” which is one artifact. Based on “op”, the rtfsd serializes the expected artifacts for that event, namely, the journal 2124 and the optional pre-image extent 2126 to Dataset: /bp/meta/rtfs/<mountID>

### Journal+Pre-Image+Snapshot Model for rtfsd

The rtfsd's protection model combines three layers:
1. rtfs journal events (WRITE, TRUNC, REMOVE, RENAME, etc.)
2. pre-images (previous bytes captured before each modification)
3. ZFS snapshots of the ‘/bp/meta/rtfs/artifacts’ dataset

Together, these provide a rollback and forensic model similar in spirit to ZFS snapshots on the data itself, but implemented using change logs rather than block-level Copy-on-Write pointers. To understand this better, it should be noted that there are two planes, namely, a data plane and a protection plane. The data plane, which houses live files, resides on a remote SMB/NAS share. The rtfs overlay (such as rtfs overlay 2118 of FIG. 23) intercepts file operations. For each modifying operation, such as the change operation in FIG. 23, the rtfs overlay emits an event containing an EventHeader (operation type, inode, file path, offset, length, timestamp), and a pre-image (bytes about to be overwritten or truncated).

In contrast to the data plane, the protection plane has artifacts which are stored on ZFS under: ‘/bp/meta/rtfs/artifacts’. The rtfsd persists each event as a JSON metadata file and a ‘.pre’ file containing raw pre-image bytes. As noted earlier, artifacts are append-only forensic records of change activity.

### What ZFS Snapshots of Artifacts Provide

The artifacts dataset is itself versioned using ZFS snapshots, taken every T seconds (default 60), with only the most recent R snapshots retained (default 5).

Each snapshot captures all rtfs events up to that point in time, represents a prefix of the journal, and behaves like a consistent forensic checkpoint. Thus, snapshot ‘S_k’ represents all artifacts as of time ‘t_k’.

This is analogous to:
“Full backup+WAL” up to time ‘t_k’.
A ZFS snapshot of the log, not the data.

### Journals+Pre-Images: Micro Checkpoints

Each rtfs event acts as a tiny, self-contained undo record:
WRITE events include pre-image bytes for the overwritten region.
TRUNC events include the truncated tail.
RENAME/REMOVE events rely on quarantined copies and metadata.
   This means:
rtfsd can reconstruct previous file states using these micro-deltas.
Even partial pre-images still provide useful rollback information.
The sequence of events is strictly time-ordered.

### Conceptually:

This is similar to a database WAL or journal file.
One can replay the journal forward or apply pre-images backward.

### Combining Journals With ZFS Snapshots

ZFS snapshots introduce macro-level checkpoints of the protection state.

Between snapshots:
rtfsd continues to append events to ‘/bp/meta/rtfs/artifacts’.
When ZFS takes a snapshot, the entire event-log-so-far is frozen.

### Thus:

ZFS snapshots=macro checkpoints of the journal itself.
rtfs events=micro checkpoints that describe exact data mutations.

Restoration Workflow

To restore a file as of time T:
1. Pick the snapshot ‘S_k’ where ‘t_k<=T<t_(k+1)’.
2. Access ‘/bp/meta/rtfs/artifacts@S_k’.
3. Load all journal events up to T.
4. Reconstruct the file by applying pre-images (backwards) or replays (forwards).
   This allows reconstruction of past file states even though the live SMB/NAS filesystem does not support snapshots.

### How This Mimics ZFS Snapshots (Conceptually)

ZFS snapshots of data:
Give instant access to file contents as of the snapshot time.
   rtfs journal+snapshots of artifacts:
Give instant access to the sequence of changes as of snapshot time.
From that, one can reconstruct the contents.
   Same conceptual rollback model:
ZFS: pointer-based time machine.
rtfs: log-based time machine.
   One stores data deltas; the other stores change deltas.

### Why Snapshots of the Journal Are Useful

Even though artifacts are append-only, snapshots provide:
1. Forensic freeze points
   A point-in-time view of exactly what the system believed happened.
2. Resilience to corruption or bugs
   If a future version of rtfsd accidentally corrupts or deletes logs, snapshots preserve earlier logs.
3. Retention windowing
   rtfsd may garbage-collect older events from the live artifact tree but snapshots ensure R earlier windows remain.
4. Consistency for investigation or restore operations
   A restore tool can mount a consistent event log from the snapshot and never worry about concurrent rtfsd writes.
      Summary of the Combined Model for rtfsd
      The combined model behaves as follows:
Journal records what changed and how it changed.
Pre-images record what used to exist before each mutation.
Snapshots freeze the history of changes so far into discrete macro-checkpoints.
   Using all three together, rtfsd offers:
Point-in-time rollback of SMB/NAS data.
Forensic replay of malicious sequences.
A predictable “flight recorder” similar in capability to ZFS snapshots, but implemented through logs and deltas.

Each third-party mount has a corresponding dataset in the security system 2100. A dataset stores artifacts (journal+extents). The dataset is on snapshot schedule (every minute), retain 5.

Snapshots will occur every minute. Snapshots include journals and extents, and 5 snapshots are maintained. As snapshots roll off, so will their related journals and extents. Journals and extents stay compact.

The rtfsd service reads the device. The RTFS dev actually publishes the events, and it publishes smaller artifacts. This rtfsd service is responsible for the journal entry and optional payload (i.e. pre-image extent), and it persists quarantine and jail artifacts. The artifacts that are stored are present in the event that a restore is needed from any kind of a malicious attack.

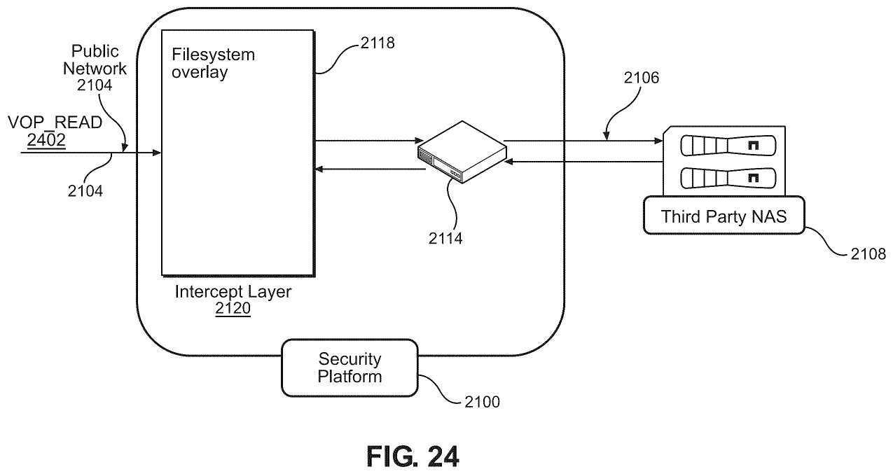

FIG. 24 is an example architecture for file activity journaling of read operations. As shown in FIG. 24, if it is determined that the operation is not a security threat and not malicious, a read operation or read function 2402 (VOP_READ) from a device or user outside the security system, such as one or more clients 2102, will go through the security platform 2100 unimpeded to the third-party storage system 2108, as no action is being done on the files of the third-party storage system 2108, in the case of the read operation 2402.

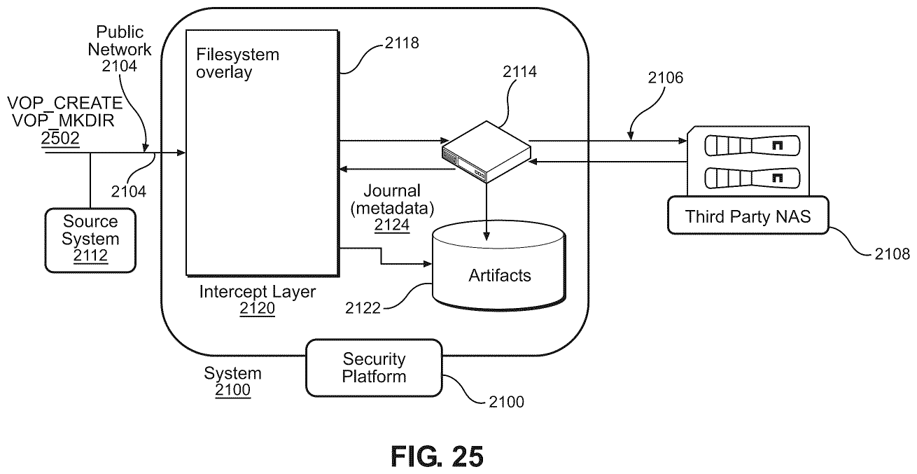

FIG. 25 is an example architecture for file activity journaling for creating files or directories. The rtfs overlay filesystem 2118 determines that there is a create operation 2502 (VOP_CREATE or VOP_MKDIR) from a source system 2112 or a client (such as one or more clients 2102) in play,. The rtfs overlay filesystem 2118 then will journal it (that is, create a journal 2124). Then, the create operation 2502 will go through the security platform 2100 to the third-party storage system 2108 once the journal 2124 is published and recorded or stored in a dataset of the security platform 2100 as an artifact 2122. It should be noted that in the case of a create operation 2502, no extent is recorded. Only the journal is recorded. Thus, by creating the artifact 2122, if it is needed, the security platform can later undo the VOP_CREATE or VOP_MKDIR operation.

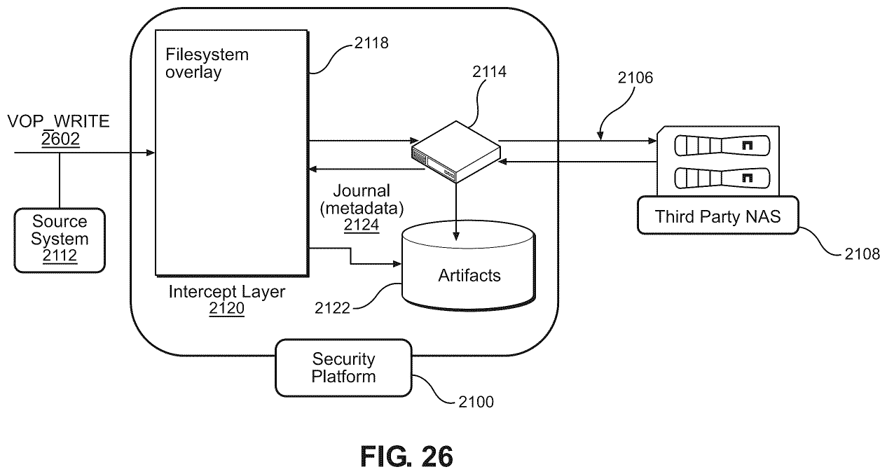

FIG. 26 is an example architecture for file activity journaling for a write new operation. As shown in FIG. 26, the rtfs overlay filesystem 2118 determines that there is a write new operation 2602 in play,. The rtfs overlay filesystem 2118 will journal it (that is, create a journal 2124). Then, the write new operation 2602 will go through to the third-party storage system 2108 once the journal 2124 is published and recorded or stored in a database as an artifact 2122. It should be noted that in the case of a write new operation 2602, no extent is recorded. There is no existing extent for recovery. By creating the artifact 2122, the security platform can perform a recovery of the file prior to changes having been made to the file, by implementing a snapshot alternative recovery as described herein using snapshots of artifacts.

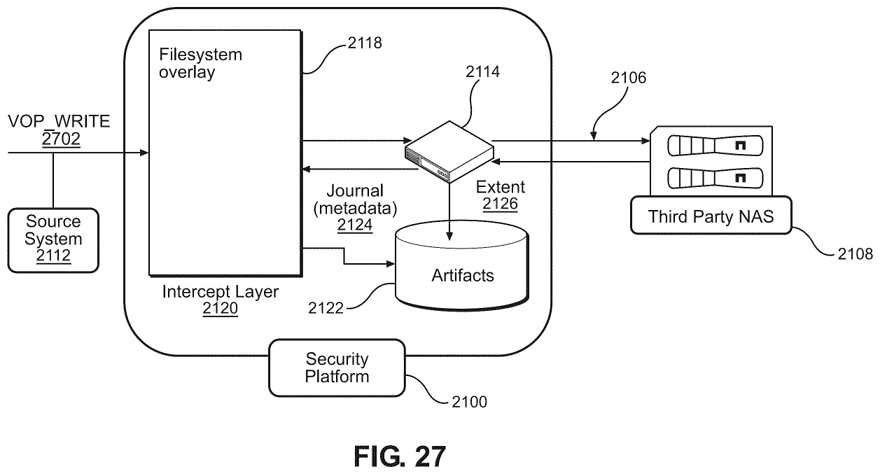

FIG. 27 is an example architecture for file activity journaling for write existing (overwrite) operation 2702. As shown in FIG. 27, the rtfs overlay filesystem 2118 determines that there is a write existing (overwrite) or overwriting operation 2702 (to overwrite data on a file that is stored in the third-party storage system 2108). The rtfs overlay filesystem 2118 will journal it (that is, create a journal 2124) and preserve the extent or the pre-image state. The existing extent 2126 will then be obtained from the third-party storage system 2108 by the device or appliance 2114. The existing extent 2126 will later be recorded or published by the security platform 2100. The write existing (overwrite) operation 2702 will go through to the third-party storage system 2108 once the journal 2124 and the extent 2126 are published and stored as an artifact 2122. By creating the artifact 2122, if it is needed, the security platform can later perform a recovery of the file prior to changes having been made to the file, by implementing a snapshot alternative recovery as described herein using snapshots of artifacts and preserved preimage states (with optional extents).

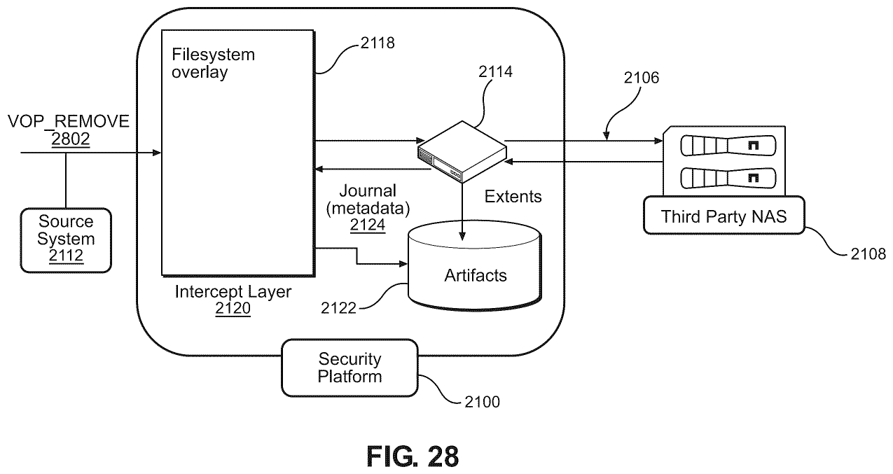

FIG. 28 is an example architecture for file activity journaling for a delete operation or remove operation (VOP_REMOVE) 2802 from the perspective of the rtfs overlay system 2118. As shown in FIG. 28, once the rtfs overlay filesystem 2118 determines that there is a delete operation of a file of the third-party storage system 2108, the rtfs overlay filesystem 2118 will journal it (that is, create a journal 2124), rename the file located on the third-party storage system 2108, and preserve the extent or the pre-image state. Specifically, the rtfs overlay filesystem 2118 will rename the file to be a quarantine file (.quarantine file) in the same folder. Thus, the delete operation 2802 is converted to a rename operation on the third-party storage system 2108. No direct deletes of any files of the third-party storage system 2108 are allowed. The rtfs overlay filesystem 2118 publishes the event via rtfs_dev. The delete operation 2802 will go through to the third-party storage system 2108 once the journal 2124 and the extent 2126 are published and stored as an artifact 2122. By creating the artifact 2122, if it is needed, the security platform can later perform a recovery of the file prior to changes having been made to the file, by implementing a snapshot alternative recovery as described herein using snapshots of artifacts and preserved preimage states (with optional extents).

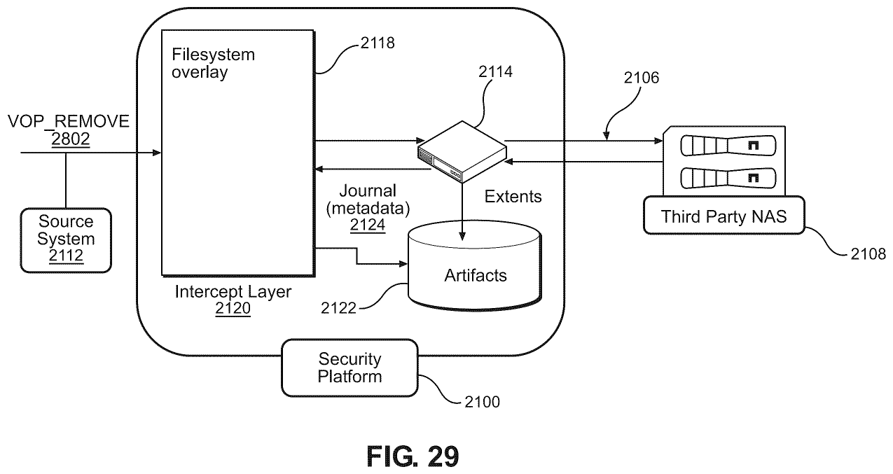

FIG. 29 is an example architecture for file activity journaling for a remove operation (VOP_REMOVE) 2802′ from the perspective of the rtfsd service of the security platform 2100. As shown in FIG. 29, the rtfs overlay filesystem 2118 determines that there is a remove operation of a file of the third-party storage system 2108 in play. The rtfs overlay filesystem will journal it (that is, create a journal 2124), rename the file located on the third-party storage system 2108, and preserve the extent or the pre-image state. Specifically, the rtfs overlay filesystem 2118 will rename the file to be a quarantine file (.quarantine file) in the same folder. The rtfsd service reads the event. Then, the rtfsd jobManager job copies the file to the security platform 2100. The rtfsd service removes the .quarantine file when the copying of the file has been completed. To recover the data, the recovery plan is to check the quarantine file first, and then check the live filesystem or snapshots, in case the offload of the quarantine file had not completed.

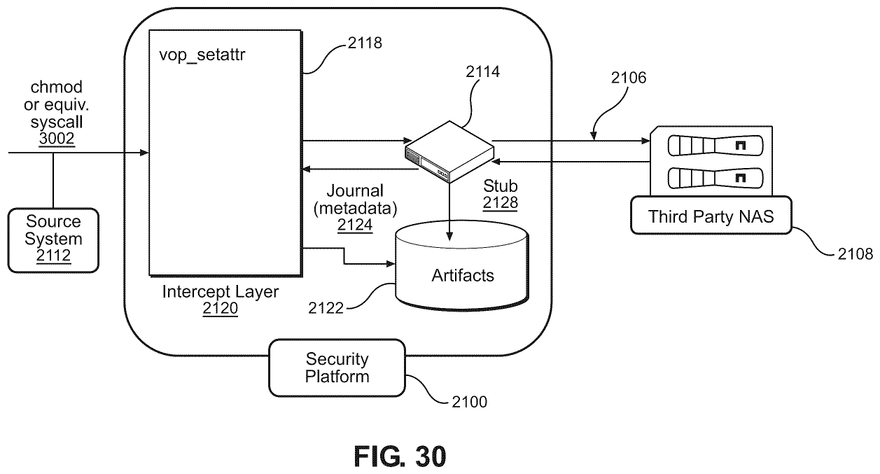

FIG. 30 is an example architecture for file activity journaling for ACL (access control list) changes, or permissions/owner/group changes. As shown in FIG. 30, once the intercept layer 2120 determines that there is a change operation 3002 (e.g., a chmod or equivalent syscall), an empty file or stub on the security platform 2100 will be created by using a copy library. The intercept layer 2120 of the security platform 2100 will then determine if any permissions are being changed. If so, then the security platform 2100 will journal it and preserve the extent or the pre-image state. That is, the security platform 2100 will preserve all “pre” or “before” permissions (the permissions before changes were implemented), ACLs, etc. Stubs will guide the recovery. The change operation 3002 will go through to the third-party storage system 2108 once the journal 2124 and a change stub 2128 are published and recorded as artifacts 2122. By creating the artifact 2122, if it is needed, the security platform can later perform a recovery prior to changes having been made to the ACL or permissions/owner/group changes, by implementing a snapshot alternative recovery as described herein using snapshots of artifacts and preserved preimage states (with optional extents).

It will be understood that the descriptions and elements of FIGS. 21-30 can be combined, added, included, removed, changed, enhanced, merged, or otherwise modified using the descriptions and elements of FIGS. 1-20, and the scope of the invention is not limited solely to what is depicted in a figure independent from the other figures. As a non-limiting example, the method steps as depicted in FIGS. 22A and 22B and described herein can be combined, removed, changed, replaced, added, or otherwise modified with the steps of any other method also described herein. Also, any of the system figures of the present disclosure (including, but not limited to, FIGS. 21 and 23-30) can be implemented in a computing system of FIG. 12, in accordance with some embodiments.

What is claimed is:

1. A system comprising:
an architecture coupled to a third-party storage system that provides file access to a plurality of users, the architecture being configured to protect the third-party storage system in a zero-trust manner from a malicious attack by a source system, the architecture comprising a controller that is configured to:
mount files of the third-party storage system;
intercept, in real time, file-level operations of the files in the third-party storage system that are indicative of a malicious event;
prevent data exfiltration or data corruption of the files;
provide an alert to an administrator regarding the files;
preserve a snapshot of an artifact associated with the files, so that one or more portions of the files that have been modified or deleted are recoverable to prior versions based on the snapshot, where the artifact comprises a journal of the malicious event;
identify the files that were associated with the malicious event;
present a graphical user interface that allows for restoration of the one or more portions of the files from the snapshot of the artifact associated with the files of the third-party storage system; and
restore the one or more portions of the files as requested.

2. The system according to claim 1, wherein the step of mounting the files further comprises mounting the files of the third-party storage system via a private network using a protocol, resulting in a mountpoint that resolves to a third-party storage system share.

3. The system according to claim 2, further comprising a SMB server that is positioned in front of the mountpoint and is configured to republish the files of the third-party storage system.

4. The system according to claim 1, wherein the third-party storage system comprises a Network Attached Storage (NAS).

5. The system according to claim 1, wherein the artifact further comprises an optional extent that includes a pre-image state of the files.

6. The system according to claim 1, wherein the step of intercepting, in real time, file-level operations of the files further comprises:
creating journals;
publishing journals with an optional extent; and
preserving one or more pre-image states of the files of the third-party storage system.

7. The system according to claim 1, wherein the controller is further configured to rolling-snapshot the journal and utilize the snapshots of the artifacts to execute the restoration of the one or more files.

8. The system according to claim 1, wherein the file-level operations comprise at least one of change operations, write operations, truncate operations, and delete/remove operations.

9. The system according to claim 1, wherein the step of intercepting, in real time, file-level operations of the files is performed by an overlay filesystem of the controller.

10. The system according to claim 9, wherein the overlay filesystem further comprises an intercept layer to preserve the one or more pre-image states of the files of the third-party storage system.

11. A method comprising:
enabling a microservices architecture on a third-party storage system that provides file access to a plurality of users, the microservices architecture being configured to protect the third-party storage system in a zero-trust manner from a malicious attack by a source system;
mounting files of the third-party storage system;
intercepting, in real time, file-level operations of the files in the third-party storage system that are indicative of a malicious event;
preventing data exfiltration or data corruption of the files;
providing an alert to an administrator regarding the files;
preserving a snapshot of an artifact associated with the files, such that one or more portions of the files that have been modified or deleted are recoverable to prior versions based on the snapshot, where the artifact comprises a journal of the malicious event;
identifying the files that were associated with the malicious event;
presenting a graphical user interface that allows for restoration of the one or more portions of the files from the snapshot of the artifact associated with the files of the third-party storage system; and
restoring the one or more portions of the files as requested.

12. The method according to claim 11, wherein the step of mounting the files further comprises mounting the files of the third-party storage system via a private network using a protocol, resulting in a mountpoint that resolves to a third-party storage system share.

13. The method according to claim 11, further comprising a SMB server that is positioned in front of the mountpoint and is configured to republish the files of the third-party storage system.

14. The method according to claim 13, wherein the third-party storage system comprises a Network Attached Storage (NAS).

15. The method according to claim 11, wherein the artifact further comprises an optional extent that includes a pre-image state of the files.

16. The method according to claim 11, wherein the step of intercepting, in real time, file-level operations of the files further comprises:
creating journals;
publishing journals with an optional extent; and
preserving one or more pre-image states of the files of the third-party storage system.

17. The method according to claim 11, further comprising rolling-snapshotting the journal and utilizing the snapshots of the artifacts to execute the restoration of the one or more files.

18. The method according to claim 11, wherein the file-level operations comprise at least one of change operations, write operations, truncate operations, and delete/remove operations.

19. The method according to claim 11, wherein the step of intercepting, in real time, file-level operations of the files is performed by an overlay filesystem of the controller.

20. The method according to claim 19, wherein the overlay filesystem provides an intercept layer to preserve the one or more pre-image states of the files of the third-party storage system.
